(19) United States
(12) Patent Application Publication
(10) Pub. No.: US 2010/0106654 A1
(43) Pub. Date: Apr. 29, 2010

(54) MANAGING AND MEMORIALIZING DESIGN REQUIREMENTS OF A BUILDING PROJECT

(75) Inventors: Larry Wayne Simpson, Overland Park, KS (US); Donald Irving Grinberg, Boston, MA (US)

Correspondence Address: SHOOK, HARDY & BACON LLP;INTELLECTUAL PROPERTY DEPARTMENT, 2555 GRAND BLVD, KANSAS CITY, MO, 64108-2613, US

(73) Assignee: HNTB HOLDINGS LTD, Kansas City, MO (US)

(21) Appl. No.: 12/436,618

(22) Filed: May 6, 2009

Related U.S. Application Data
(60) Provisional application No. 61/106,151, filed on Oct. 16, 2008.

(51) Int. Cl. G06Q 10/00; G06F 17/30; G06F 15/16; G06F 3/048

(52) U.S. Cl. 705/300; 709/206; 715/760; 715/738; 707/E17.044

(57) ABSTRACT

Methods, system, and media are described herein for receiving design requirements associated with a building project from remote devices over the Internet and storing design requirements and changes to design requirements, including user-defined categories, and user information and comments regarding design requirements, in an extensible data structure, which automatically extends itself without a need for user-provided programmatic code. The design requirements are gathered and stored in such a way that a building program (also known as an “architectural program”) can be automatically generated on demand.

### CROSS-REFERENCE TO RELATED APPLICATIONS

This application claims the benefit of U.S. Provisional Application No. 61/106,151, filed Oct. 16, 2008, which is hereby incorporated by reference in its entirety.

### SUMMARY

Embodiments of the invention are defined by the claims below, not this summary. A high-level overview of various aspects of the invention are provided here for that reason, to provide an overview of the disclosure, and to introduce a selection of concepts that are further described in the detailed-description section below. This summary is not intended to identify key features or essential features of the claimed subject matter, nor is it intended to be used as an aid in isolation to determine the scope of the claimed subject matter.

In an aspect of an embodiment of the present invention, textual design requirements associated with a physical structure are received from multiple users over the Internet and stored in an extensible database. Design requirements may be stored in user-defined categories, and design requirements are viewable and editable by multiple users of remote computing devices. The design requirements in an embodiment are automatically associated with fields for entry of data and comments by users.

### BRIEF DESCRIPTION OF THE SEVERAL VIEWS OF THE DRAWINGS

Illustrative embodiments of the present invention are described in detail below with reference to the attached drawing figures, and wherein:

FIG. 1 is a block diagram illustrating exemplary devices suitable for operation of an embodiment of the present invention;

FIG. 2 is a block diagram illustrating exemplary devices suitable for operation of an embodiment of the present invention;

FIGS. 3A-3E are database schema illustrating an exemplary data structure in accordance with an embodiment of the present invention;

FIG. 4 is a screenshot depicting an exemplary user interface displaying a requirement in accordance with an embodiment of the present invention;

FIG. 5 is an illustrative view depicting input areas in accordance with an embodiment of the present invention;

FIG. 6 is a screenshot depicting an exemplary user interface with categories of design requirements in accordance with an embodiment of the present invention;

FIG. 7 is an illustrative interface depicting requirement categories in accordance with an embodiment of the present invention;

FIG. 8 is a screenshot depicting an exemplary user interface displaying an outline and rooms in accordance with an embodiment of the present invention;

FIG. 9 is a screenshot depicting an exemplary user interface displaying an outline and requirements in accordance with an embodiment of the present invention;

FIG. 10 is an illustrative interface depicting an exemplary outline in accordance with an embodiment of the present invention;

FIG. 11 is an illustrative interface depicting an exemplary outline in accordance with an embodiment of the present invention;

FIG. 12 is an illustrative interface depicting exemplary design requirements in accordance with an embodiment of the present invention;

FIG. 13 is an illustrative interface depicting exemplary design requirements in accordance with an embodiment of the present invention;

FIG. 14 is an illustrative interface depicting exemplary design requirements in accordance with an embodiment of the present invention;

FIG. 15 is an illustrative interface depicting exemplary design requirements in accordance with an embodiment of the present invention;

FIG. 16 is an illustrative interface depicting exemplary design requirements in accordance with an embodiment of the present invention;

FIG. 17 is an illustrative interface depicting exemplary design requirements in accordance with an embodiment of the present invention;

FIG. 18 is an illustrative interface depicting exemplary design requirements in accordance with an embodiment of the present invention;

FIG. 19 is an illustrative interface depicting exemplary design requirements in accordance with an embodiment of the present invention;

FIG. 20 is an illustrative interface depicting exemplary design requirements in accordance with an embodiment of the present invention;

FIG. 21 is an illustrative view depicting a list of requirements in accordance with an embodiment of the present invention;

FIG. 22 is an illustrative interface depicting an exemplary use of data in accordance with an embodiment of the present invention;

FIG. 23 is an illustrative interface for accessing data in accordance with an embodiment of the present invention;

FIG. 24 is an illustrative interface for selecting project information in accordance with an embodiment of the present invention;

FIG. 25 is an illustrative interface depicting options in accordance with an embodiment of the present invention;

FIGS. 26 and 27 illustrate exemplary roles and permissions in accordance with an embodiment of the present invention;

FIG. 28 is an illustrative interface depicting an exemplary display of comments in accordance with an embodiment of the present invention;

FIG. 29 is an illustrative interface depicting an exemplary outline in accordance with an embodiment of the present invention;

FIG. 30 is a screenshot depicting an exemplary user interface in accordance with an embodiment of the present invention;

FIG. 31 is a screenshot depicting an exemplary user interface in accordance with an embodiment of the present invention;

FIG. 32 is an illustrative interface depicting an exemplary embodiment of the present invention;

FIG. 33 is an illustrative interface depicting an exemplary embodiment of the present invention;

FIG. 34 is an illustrative interface depicting an exemplary display of a resource section in accordance with an embodiment of the present invention;

FIG. 35 is a diagram of an exemplary diagram of a method in accordance with an embodiment of the present invention; and

FIG. 36 is a diagram of an exemplary diagram of a method in accordance with an embodiment of the present invention.

### DETAILED DESCRIPTION

The subject matter of embodiments of the present invention is described with specificity herein to meet statutory requirements. But the description itself is not intended to necessarily limit the scope of claims. Rather, the claimed subject matter might be embodied in other ways to include different steps or combinations of steps similar to the ones described in this document, in conjunction with other present or future technologies. Terms should not be interpreted as implying any particular order among or between various steps herein disclosed unless and except when the order of individual steps is explicitly described.

Throughout this disclosure, several acronyms and shorthand notations are used to aid the understanding of certain concepts pertaining to the associated system and services. These acronyms and shorthand notations are intended to help provide an easy methodology of communicating the ideas expressed herein and are not meant to limit the scope of the present invention. The following is a list of these acronyms and shorthand notations:
.ASPX file File used with a web application framework, such as an ASP.NET source file
.NET software framework
AJAX Asynchronous JavaScript+XML (Extensible Markup Language)
API Application Programming Interface
ASP.NET Web application framework (successor to “Active Server Pages”) for dynamic web applications using the .NET software framework
BIM Building Information Model
C# “C-sharp”—Programming language used with .NET framework
CAD Computer-Aided Design
COBIE Construction Operations Building Information Exchange system
CSS Cascading Style Sheets
IFC file Industry Foundation Classes compliant file
LEED Leadership in Energy and Environmental Design
OPS Onuma Planning Systems
SQL Structured Query Language

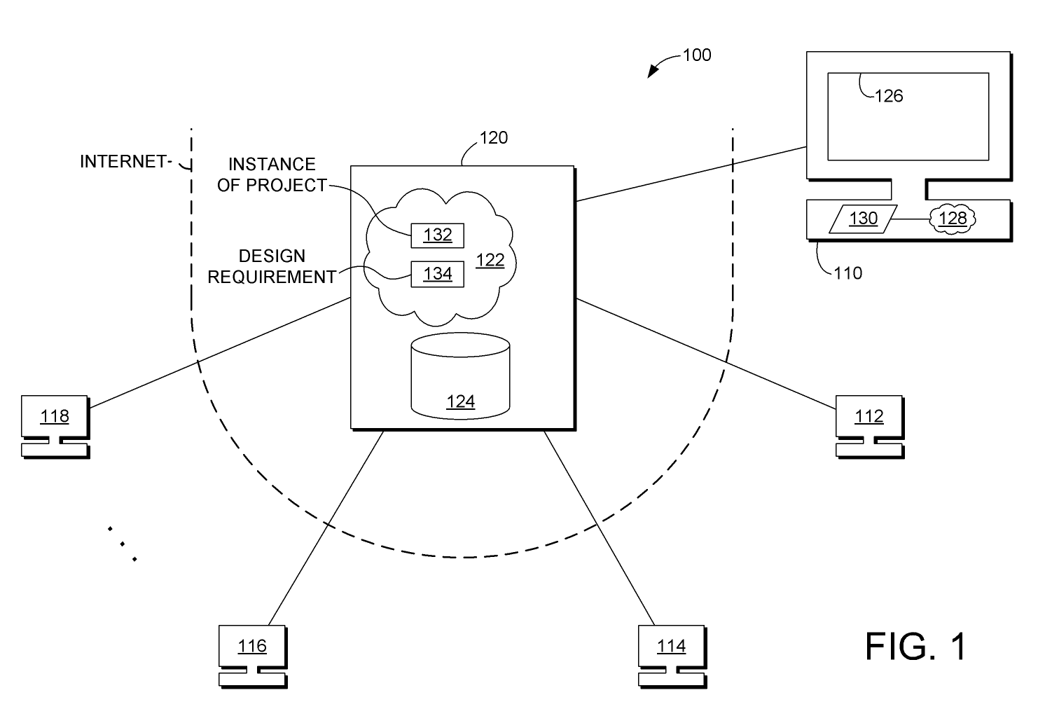

Turning to FIG. 1, an exemplary embodiment according to the present invention is shown generally as 100. Devices 110, 112, 114, 116 and 118 are connected to server 120 over an Internet connection from remote locations, and in one embodiment, are general-purpose computing devices, which include one or more processors, memory, mass-storage devices and input/output ports that process computer-executable instructions. Illustrative computing devices include personal computers, servers, laptops, workstations, and even some mobile devices.

Devices 110 through 118 enable users in different locations to contribute, view and edit design requirements for a physical structure to be made consistent with the design requirements. For example, a physical structure may be a convention center to be made consistent with design requirements including a lobby, a parking lot, and an exhibition hall. Design requirements of a lobby may include security features and signage, and aspects of a parking lot may include landscaping and lighting. In an embodiment, an exhibition hall includes design requirements such as dimensions, acoustics, utilities and windows.

Although five devices are shown as an example in FIG. 1, any number of remote computing devices, such as 100 devices or 1,000 devices, may be used in accordance with the present invention. An Internet connection between devices 110 through 118 and server 120 can be an ongoing connection, one-time data transmissions, such as electronic mail, or a connection with periods of offline activity. In an embodiment, device 110 can connect to server 120 by routing through another device or proxy server.

In an embodiment in FIG. 1, server 120 is connected to devices 110 through 118. Server 120 includes application 122 and database 124. Database 124 could be included on the server 120, as illustrated in FIG. 1. In another embodiment, server 120 is in communication with database 124 through a local or network connection. Database 124 could be proximate to server 120 or remotely located from server 120. An embodiment includes database fragments stored in more than one location and accessible by server 120.

In an embodiment of the present invention, an instance of a building project 132 (“project” 132) is received by server 120. Project 132 may be received from any device 110 through 118, or in another embodiment, project 132 is received from database 124. As shown in the example in FIG. 1, server 120 receives design requirement 134. Server 120 can store project 132 and design requirement 134 in database 124. In one example, project 132 is associated with design requirement 134 and stored in a hierarchal relationship in database 124.

Users of devices 110 through 118 could input design requirements associated with aspects of a convention center. As a specific example, design requirement 134 indicates the convention center will include an exhibition hall. Another example of a design requirement 134 is that an exhibition hall will have a minimum vertical clearance of a certain height. It would be futile to attempt to exhaustively list design requirements, but other examples include rooms, indoor and outdoor spaces, and categories of requirements, such as electrical, mechanical and plumbing systems. In embodiments of the present invention, design requirements can include values of dimensions of a physical structure, occupancy requirements, video surveillance, and ventilation requirements of a physical structure. Design requirements may be spaces and may be defined by spatial or functional criteria in embodiments of the present invention. Additional examples of design requirements are discussed below.

Remote computing device 110 in FIG. 1 includes user interface 126 and web-based browser application 128 (“browser 128”). Browser 128 communicates with server 120 over the Internet. In an embodiment, design requirement 134 is a new design requirement added by a user of device 110. The database is extensible based on spaces or requirements received from multiple users, discussed in more detail below. Users in various geographical locations may add requirements that are viewable by other users. In an embodiment, one user is able to work on a project from more than one device 110 through 118, without downloading additional programs or applications locally.

An embodiment of the present invention is capable of operating with user interface 126 and browser 128 at remote computing device 110. In embodiments of the present invention, no other programs or applications must be downloaded or run by remote computing devices 110 through 118. With reference to FIG. 1, in an embodiment, application 122 allows users to contribute design requirements, such as requirement 134, thereby extending the database 124 structure.

The present invention enables embodiments where multiple users can direct extension of the database 124 from different locations through a browser, such as browser 128. In a specific example, a user may contribute building-project information from one device 110 at work and another device 112 at home. The user would not be required to download, install, run, or execute additional programs or software. In some cases, another device 112 used by a user may be a mobile device, potentially with less capacity for additional programs or software.

In an embodiment, no coding or other commands are required from a user to effectuate extension of database 124 beyond inputting design requirement 134. In an embodiment, inputting requirements include selecting an add option presented on the user interface 126. Database 124 accommodates addition of design requirement 134 related to any aspect or level of a structure or space to be built (or being built) or modified. The number of requirements stored is not limited, and addition of design requirement 134 to database 124 is permitted at any level of detail.

Multiple users are able to add design requirements that will be stored in database 124. Users may make changes to existing design requirements, such as requirement 134. In a specific example, design requirement 134 indicates the vertical clearance of an exhibition hall will be thirty feet. In one embodiment, the same user that entered design requirement 134 makes a change to requirement 134. In another embodiment, the change to requirement 134 is made by a different user from a remote device.

Embodiments of the present invention preserve all received data, including changes to data, by multiple, remote users. By archiving historical data, the database 124 is capable of providing any version of requirements and/or comments related to requirements. In an embodiment, database 124 can provide data according to contributions from certain user(s), such as requirements, edits, and/or comments from a user. In an embodiment, a comparison of versions may identify all edits to requirements 134 or a group of requirements. Comparisons may determine edits by certain user(s), or data or changes according to time-based criteria. Requirements, or changes to requirements, may be presented via the user interface 126, as discussed in more detail below. Data in embodiments of the present invention could be time stamped, sorted by topic, or tracked in a way that permits restoration to time points or other points during a project. In an embodiment, a request for information from database 124 is restricted by time criteria and/or presented information has been filtered by date(s).

Design requirements in accordance with the present invention are generally viewable as alpha-numeric text, as opposed to graphical representations. Additions to stored data by multiple users may be more efficient, accessible, or useful with textual information, particularly from types of remote computing devices with different levels of display or input capabilities. Textual information, including numerals and other values and symbols, facilitates determining changes to requirements by multiple users. Text can be presented in a comparison format, such that changes are tracked and/or apparent to a user. In some embodiments, text in database 124 may be searched by a user. As discussed below with respect to specific embodiments of the present invention, textual information may be copied and edited by users.

Requirement 134 may be any length or occupy any number of fields in a database 124 or user interface 126. There is no limit to the level of detail possible with embodiments of the present invention. There is no limit to the amount of changes to requirement 134 possible, which may be viewed as different versions or in a view that indicates changes, potentially by time and/or user and with comments or requirements contributed by other users from remote locations. Requirement 134 related to physical structures can be voluminous or expressed as lengthy or edit-enabled descriptions in embodiments of the present invention. Design requirement 134 may include numerals, units, formulas, or individual values.

Embodiments of the present invention use metadata to permit entries by users without additional coding or templates. Database 124 is extensible, indicating the data structure may expand at multiple levels to accommodate requirements, changes, comments, projects, or users. Although interoperability is contemplated by the present invention, including embodiments that output data to other applications or programs, extensibility indicates aspects of data storage such as flexibility and expansion. Database 124, in an embodiment of the present invention, extends based on configurable metadata associated with entries or changes from users, or new users. Application 122 processes metadata in one embodiment. In a specific example, database 124 is a database managed by SQL stored on server 120.

Database 124 may extend by storing data in structures or schema based on information included with contributions by users. This allows users of embodiments of the present invention to affect the data or data structure without adding code or templates, which may introduce instability or security issues in situations with multiple users or affect the capability of users to contribute. Contributions in the present invention may include receiving directions or commands from a user regarding an existing requirement or comment. Certain metadata may be configured by users in embodiments of the present invention. For example, a user may copy design requirement 134 from one level of a hierarchy to another level, which configures metadata associated with requirement 134 and affects storage of requirement 134 in database 124. In embodiments of the present invention, multiple users are able to use and manipulate data stored in database 124 by taking steps that cause metadata to be configured. In some cases, users may be unaware of the metadata configuration or effects on a data structure.

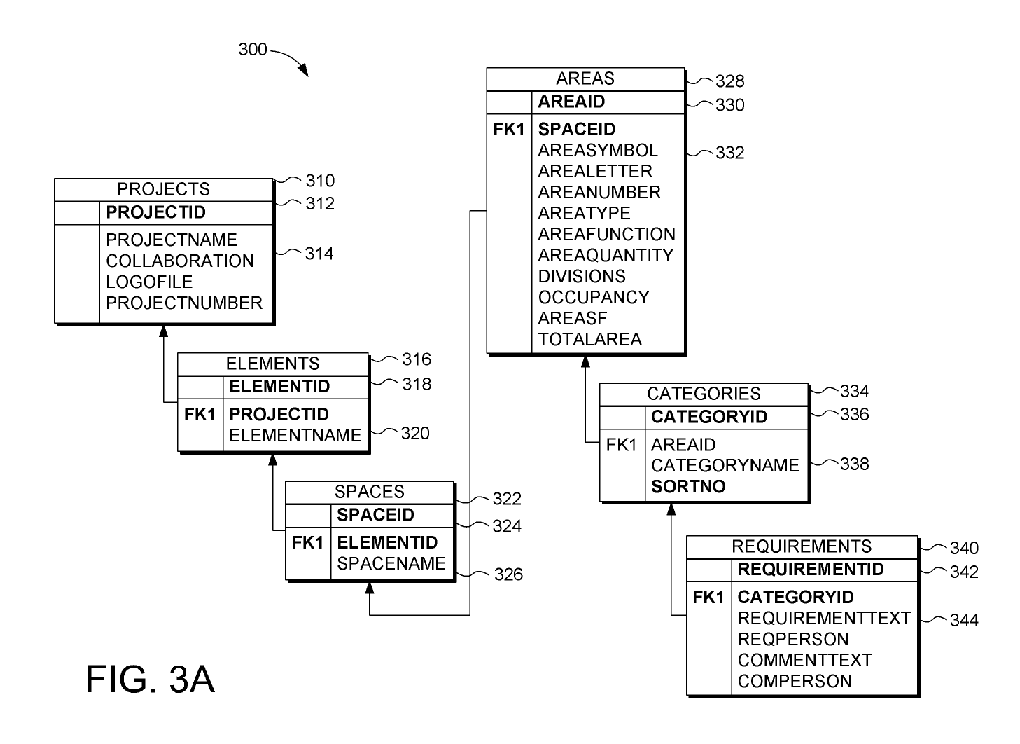

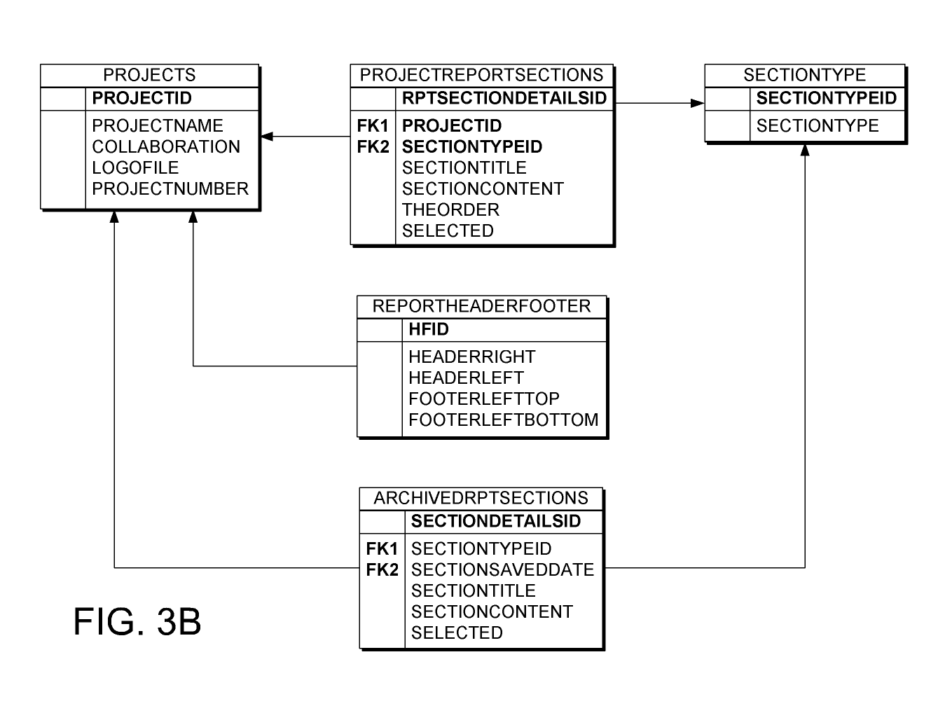

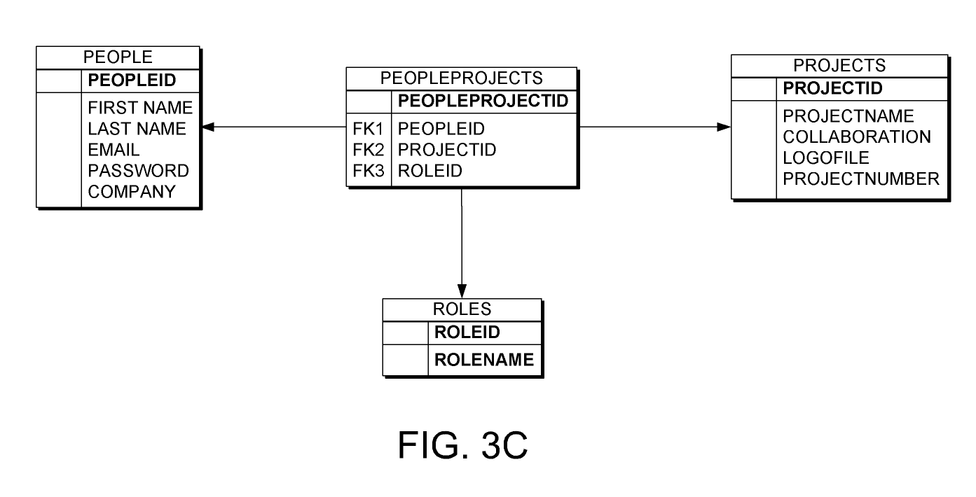

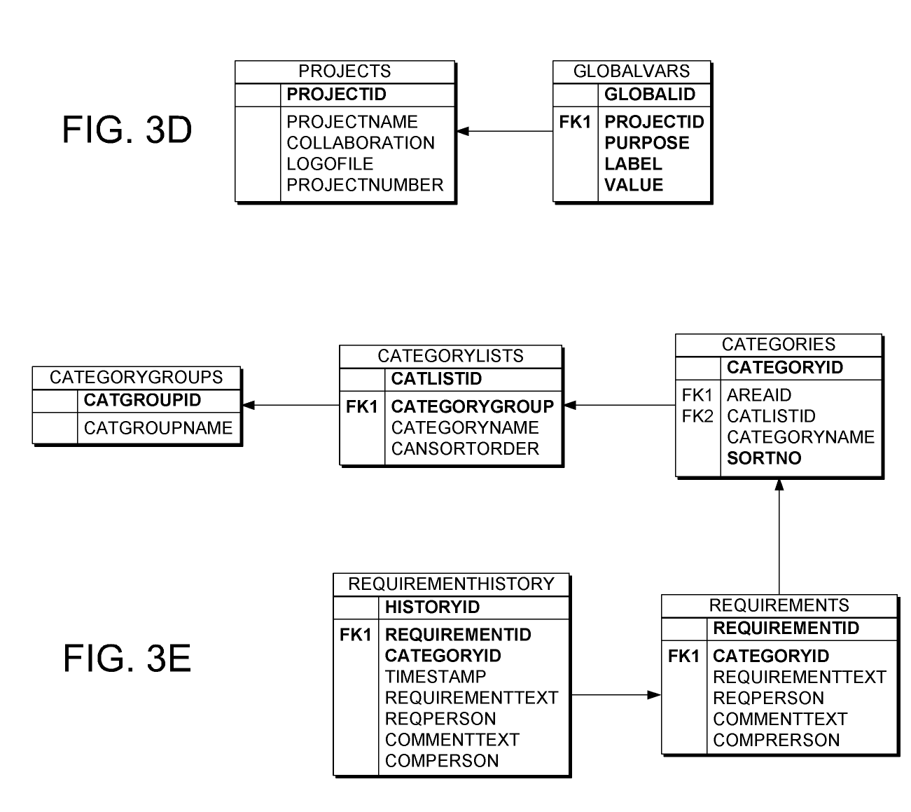

Embodiments of the present invention extend database 124 through the addition of design requirements 134 and changes to requirements 134, including comments that can be associated with individual data fields. Additionally, embodiments of the present invention extend data and the corresponding structure in database 124 by allowing copying and pasting of requirements 134. As discussed below, requirement 134 is selected by a user for copying, then pasted in an embodiment. Database 124 may use or store metadata to create a new relationship in a data structure, such as the exemplary structure shown in FIG. 3, as opposed to creating and storing a copy of the data.

One use for querying, viewing, and copying design requirements 134 associated with one project 132, such as a convention center, is with respect to a second instance of a requirement within the same project or a second instance of a project. The second instance of a project may be an existing project or a new project. The projects 132 may be stored in the same database 124 in embodiments of the present invention, or one may be stored on a separate device that is also accessible by server 120. The same processes described herein as used between projects apply between parts of projects or multiple instances of projects. In embodiments of the present invention discussed herein, more than one design requirements 134 at one level are selected based on the selection of a single design requirement 134 at a higher level.

Examples of query or selection criteria used on existing design requirements 134 are too numerous to practicably list but include requirements associated with areas such as bathrooms or exterior spaces, requirements associated with certain engineering or physical standards, or date restrictions. Design requirements 134, stored then selected in accordance with an embodiment of the present invention, may be saved as a new project 132 or copied and pasted to a new or existing project 132.

In one specific example, a new project 132 calls for a handicap-accessible restroom as a design requirement 134. Users may query or view requirements associated with accessible restrooms in database 124. The selected requirements, related to an accessible restroom in this example, may be saved or copied in embodiments of the present invention.

In an embodiment of the present invention, design requirements 134 are ultimately included in a resource, shown, for example, as resource 130 in FIG. 1. Data and metadata, stored in database 124, for example, may be sources of information for a resource 134. Resource 134 captures or documents design requirements related to a physical structure. In an embodiment, one user may direct creation of resource 130, or multiple users may contribute to its creation. In a specific example, device 110 in FIG. 1 directs production of resource 134. Resource 134 can be commanded from one remote location and received in another location.

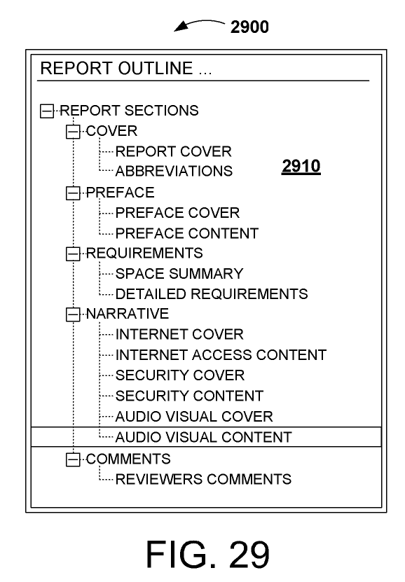

Data structures, and textual requirements and comments, in the present invention facilitate the relatively rapid and coordinated production of resource 134. Resource 134 is produced physically, such as by a printer at the direction of a user, in an embodiment. An electronic document, including an electronic message, is a resource 134 containing design requirements 134 related to a structure in one embodiment. Aspects of a resource 134 in accordance with an embodiment of the present invention are discussed below with respect to FIGS. 29 through 34.

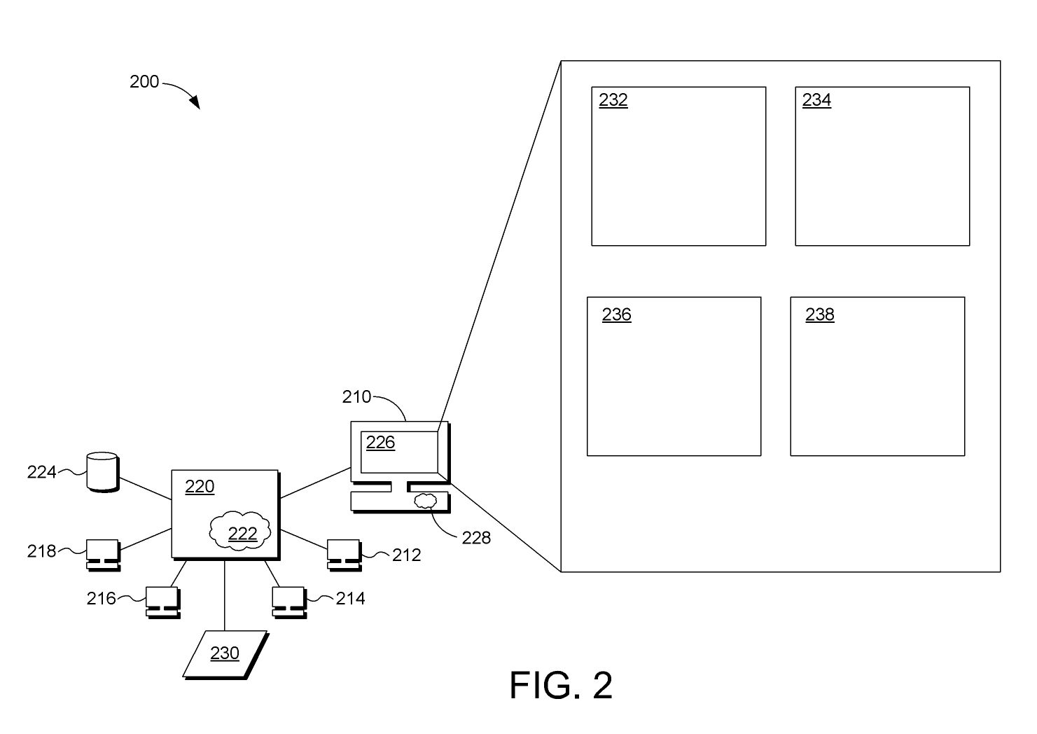

In embodiments of the present invention, design requirements are associated with related comments, or fields for receiving comments. FIG. 2 shows an exemplary embodiment of the present invention, designated generally as 200, with requirement 234 and field 236, which may be used by any user to input comment 238. A user of any device 210 through 218 is able to enter requirement 234, or comment 238 related to requirement 234, from a remote location. In embodiments of the present invention, comment 238 may be incorporated into requirement 234.

In an exemplary embodiment of the present invention, browser 228 communicates with application 222, which includes a user interface layer, business logic layer and data layer in communication with server 220, or included on server 220, which is connected to database 224. Each layer may include one or more additional layers. Application 222 includes layers programmed using a language, such as C#.NET. The user entering a comment related to requirement 234 does not have to be the same user that entered requirement 234. In fact, users may be more inclined to comment on requirement 234 than change requirement 234 in some cases. By sharing data, including comments, among multiple users in remote locations and providing updates, an embodiment of the present invention contemplates interaction among team members to develop design requirements 234. In an example, questions relating to requirement 234 may be handled as edits to the data or as comments.

According to one embodiment of the present invention, comments are viewed as discussed in specific examples below. For example, comments that have not been addressed satisfactorily are presented in an embodiment. In another embodiment, requirements and/or comments from one or more users are viewable based on characteristics of the users, such as users' roles on a project team. A user may view comments and requirements 134 in a single interface, where edits are incorporated in part of the view and the other part of the view is not apparently affected by the edits.

As shown in FIG. 2, resource 230 may be created or presented by embodiments of the present invention. In one example, user of device 210 directs creation of a resource 230. In one embodiment, resource 230 is directed to a printer or other device connected to server 220. In another embodiment, resource 230 is created then stored in database 224. Resource 230 may be directed over the Internet to another destination, such as an email recipient or client.

Turning now to FIGS. 3A-D, database schema in accordance with embodiments of the present invention are shown. In an embodiment illustrated in FIG. 3A, project data 310 is shown with identification information 312. Additional project information 314 is shown, such as a project name and identification number. Identification information 312 may be inherent in project 310 or additional information 314. Similarly, identification information for other aspects of a project shown in FIG. 3 and discussed below, may be inherent in or automatically derived from other data.

Element 316, in an embodiment, is stored in relation to identification information 318 and additional information 320, such as element name. Space 322, identification information 324 and additional information 326 are shown in FIG. 3, including a space name as additional information 326. As illustrated in FIG. 3, area 328 is associated with identification information 330 and additional information 332. Category 334 and identification information 336 are shown in relation to additional category information 338. Requirement 340 is associated with identification information 342 and additional information 344. In an embodiment, some of the data shown in FIG. 3 is metadata that is configured to indicate relationships in the structure.

In an exemplary database in an embodiment, requirement data 340 through 344 is stored as child data in relation to parent category data 334 through 338. As discussed below, the specific example discussed here does not preclude element 316 from being a space, area, or design requirement. Likewise, areas may be used as spaces or elements of a project in embodiments of the present invention. Data shown at any level of the exemplary structure in FIG. 3 may operate as a design requirement for use with a building project. In other embodiments, data structures may include more or less levels of data between project 310 and requirements 340.

FIG. 3B shows an illustrative database schema related to generating a resource 130 based on design requirements 124, including the project information and section information for creating resource 130. FIG. 3C shows an exemplary database schema related to users of embodiments of the present invention, including identification information and role information regarding users. FIG. 3D is an example of a database schema in one embodiment regarding project information, such as a project name and number. Turning to FIG. 3E, an exemplary database schema showing design requirements 134, including categories, and archival data.

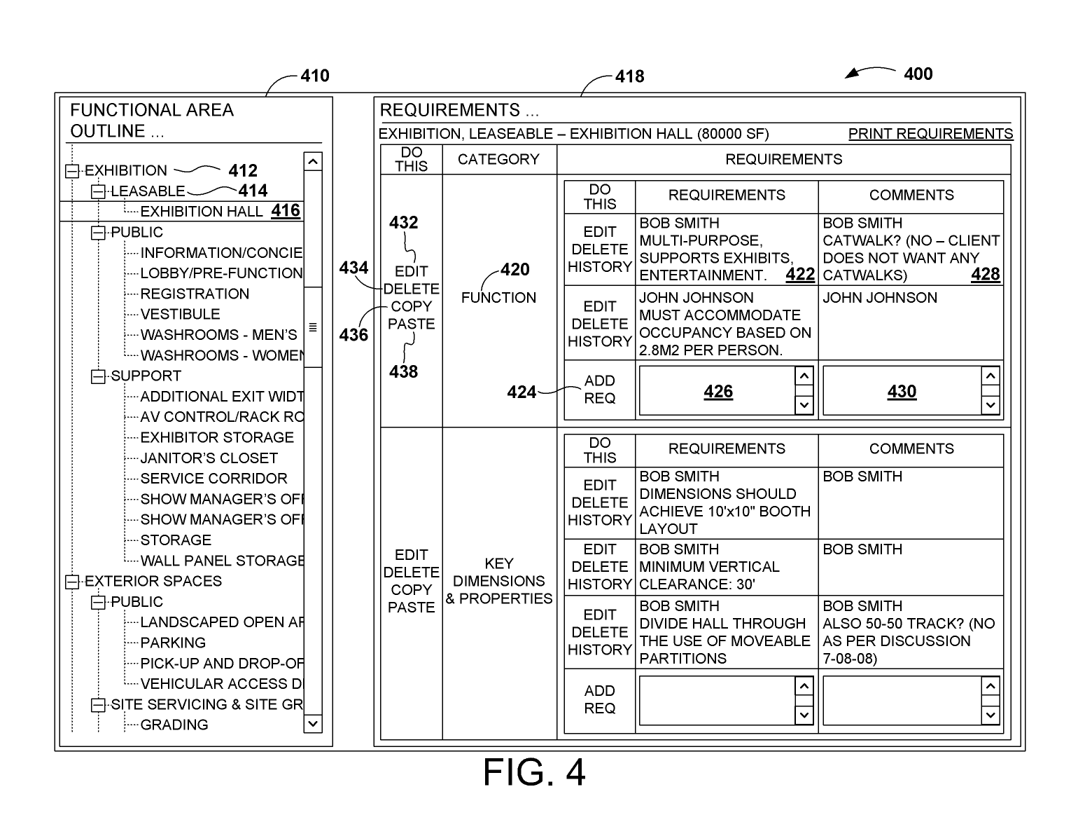

FIG. 4 illustrates an exemplary user interface for use in accordance with the present invention, designated generally as 400. In the example in FIG. 4, outline 410 includes design requirements of a convention center project including areas for exhibition (412), leasable areas (414), and exhibition hall (416). An exemplary requirements view, shown at 418 in FIG. 4, provides a category of design requirements 420 (“category 420”). The specific example in FIG. 4 shows “function” as category 420.

In an embodiment, a user is able to add a requirement through the add requirement feature shown at 424. Text is entered in field 426. In some embodiments, selecting add requirement feature 424 generates field 426. In other embodiments, selecting add requirement feature 424 facilitates receipt of the requirement by the server and/or database. A single project is capable of simultaneous presentations on multiple devices, and more than one device is capable of adding requirements to a single project during simultaneous sessions. In an embodiment shown in FIG. 4, a category of design requirements 420 is function. Requirement 422 is associated with category 420. The exemplary requirement 422 in FIG. 4 indicates an exhibition hall will be multi-purpose.

FIG. 4 illustrates an example of a comment 428 associated with design requirement 422. Comment 428 indicates no catwalks are desired in the ultimate physical construction to be built in accordance with the requirements. Field 430 enables a user to enter a comment. In the example in FIG. 4, comment 428 includes authorship or identification information corresponding to users.

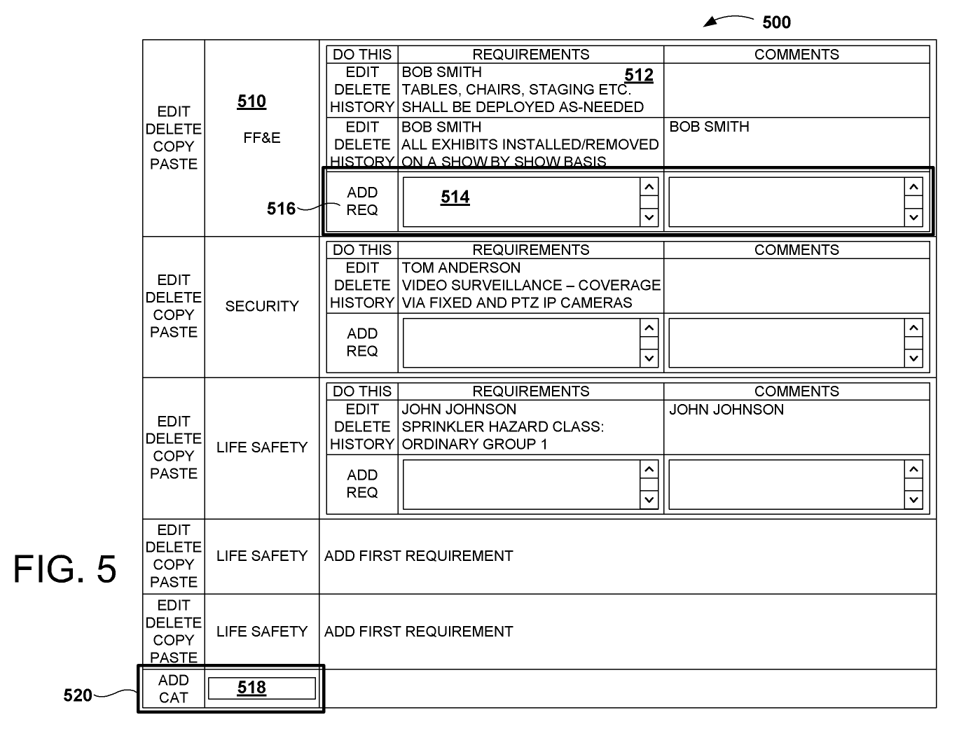

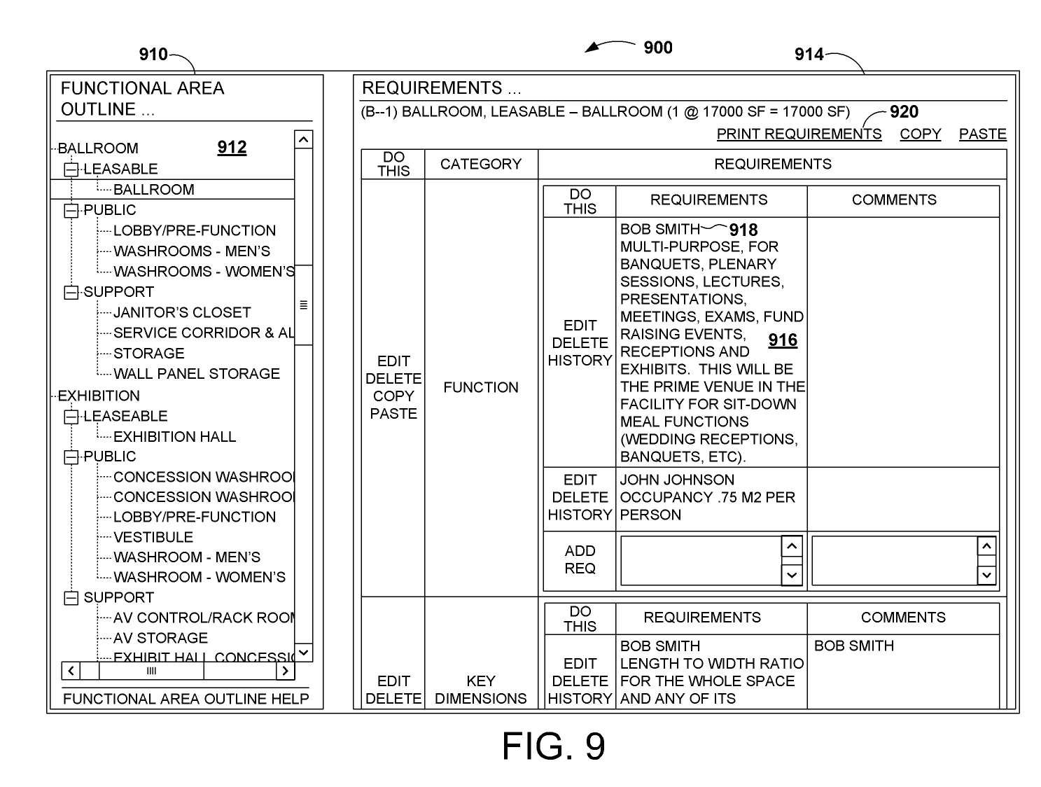

In one specific scenario, a user is identified as more experienced or as performing a certain role on a team. For instance, user John Johnson, shown in embodiments of the present invention discussed below, such as FIGS. 5 and 9, may have a lead role or relevant expertise. In some cases, contributions from a user, such as John Johnson, are determined and potentially used for further actions described herein, such as transferring data or producing a resource of design requirements. This determination is based on metadata indicating a user in an embodiment.

Embodiments of the present invention are capable of sorting design requirements and comments by metadata, or according to a data structure based on metadata. For example, in one embodiment, “John Johnson” is not entered as data, but automatically included with data entered by a user identified as “John Johnson.” In some cases, contributions by “John Johnson” are displayed, and the metadata may be used to determine these contributions. The name “John Johnson” may actually be displayed along with data entered by John Johnson in an embodiment of the present invention.

In another scenario, contributions from one user may be removed or require review. Embodiments of the present invention allow correction of errors or identification of requirements for review based on users and time periods. In a specific example, user John Johnson contributes design requirements, including changes and comments, related to a structure to be built. For example, John Johnson contributes requirements regarding a bathroom in a school building. He learns the bathroom must now be handicap-accessible. He may learn this through a change to design requirement(s) by another user, including comment(s).

For example, user Bob Smith may indicate this through a comment on a requirement regarding the bathroom, or through an electronic message to John Johnson or multiple users associated with the school project. John Johnson is able to review his own contributions, in order to change or remove them. In other cases, user-error or other circumstances surrounding a user may motivate a review of requirements entered by that user, such as termination or credibility issues, or concerns about the connection or security devices.

The examples herein regarding a user apply to more than one user. For example, John Johnson and Bob Smith both have lead roles in one embodiment. The identification of contributions by one or more users does not need to be based on static criteria. For example, John Johnson may only be identified as having expertise or a lead role for requirements associated with bathrooms. In an embodiment of the present invention, metadata automatically associated with an entry provides user identification information for future use.

Users of embodiments of the present invention navigate from one view to another through user interface 126. Data displayed to a user of a remote computing device 110 through 118 changes in response to user actions or updates. In embodiments of the present invention, one portion of a view changes. Embodiments of the present invention enable more than one portion of user interface 126 with various responses, such as various view changes or no view change, based on user actions or updates. Navigation may occur based on an entry, selection, or action by a user or computing device. For example, a user may select a link associated with a desired action, such as selecting a link representing a design requirement a user would like to edit.

Design requirements in embodiments of the present invention may be represented as links that are selected in order to display more or less detail to a user. Links on one portion of user interface 126 can change the display on a second portion of the interface 126 while preserving the first portion. In an embodiment, selection of a link in one portion changes the display of that portion, but it does not change another portion of the display. Portions of a display may include tags indicating sections, such as DIV tags. Techniques used in embodiments of the present invention are asynchronous, such as Asynchronous JavaScript and XML (AJAX), in order to preserve and update parts of a page or document, or to update or change more than one section in different ways.

Interface 126 uses cascading sheet styles in an embodiment of the present invention. In a specific example, ASPX files may be used as an embodiment of the present invention and enable dynamic web services and applications using a web application framework, such as ASP.NET. Aspects of the present invention are created using a C# programming language in an embodiment. Although data may be considered embedded in a hierarchal structure in embodiments of the present invention, all levels of data are available for display and queries in an embodiment of the present invention.

FIG. 5 is an illustrative view, indicated generally as 500, depicting input areas in accordance with an embodiment of the present invention. Design requirement category 510 includes requirement 512 and field 514. In one embodiment, requirement 512 in FIG. 5 is an existing requirement that has been stored, and field 514 is for inputting an additional requirement. Text entered into field 514 may be automatically contributed and stored. In an exemplary embodiment, an add requirement option 516 is selected to contribute text entered in field 514 as a design requirement. In some cases, add requirement option 516 is selected to generate field 514 or store entered text.

A category of requirements 510 may be input in field 518 in an embodiment, then added based on selection of an add category option 520. Field 518 is displayed in response to selection of add category option 520 in one embodiment of the present invention. As shown in FIG. 5, existing requirement 512, field 514 and field 518 may be simultaneously displayed. In an embodiment, view 500 includes stored data (512) and data input areas for receiving data that is intended for storage at more than one level (514, 518). In an embodiment, a user action, such as inputting a design requirement, extends the data structure and alters a portion of view 500, but does not alter another portion of view 500.

As a specific example, adding a new requirement category 510 through field 518 changes the requirement category portion of view 500 without changing the requirement portion of view 500. Similarly, in an embodiment, a user adds a design requirement 512 by entering text in field 514, and the requirement portion of view 500 is updated to reflect the additional design requirement 512. In this case, the requirement category portion of view 500, which is stored at a higher level in the corresponding data structure, does not change during the addition of design requirement 512.

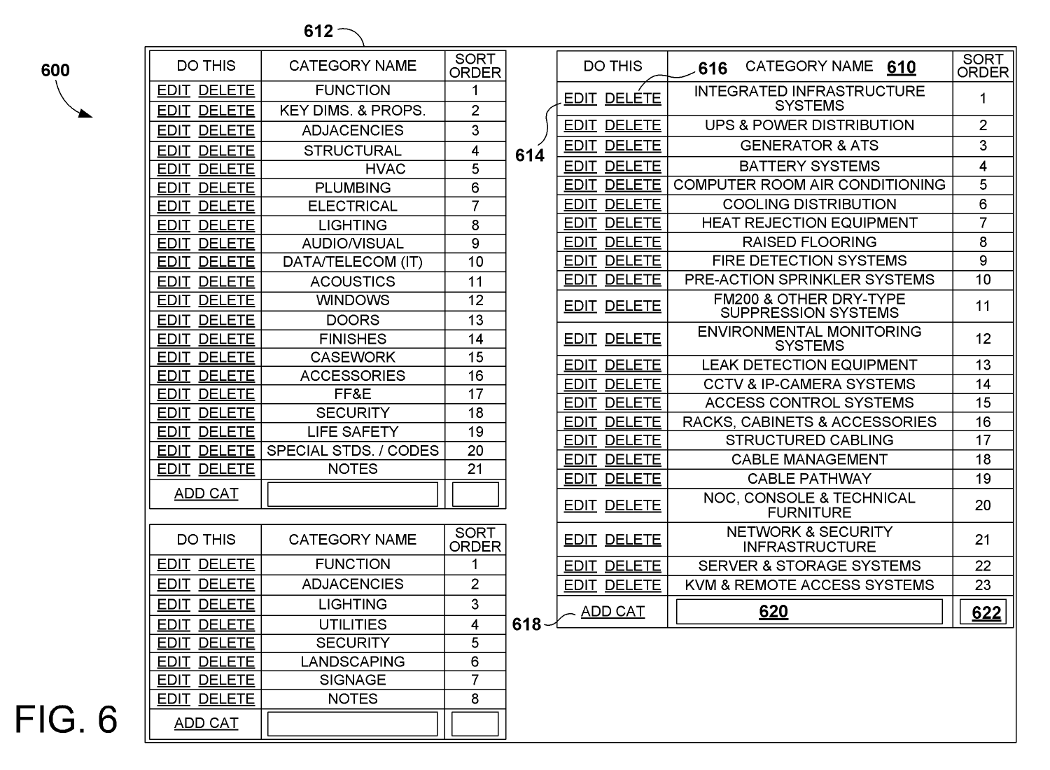

FIG. 6 is a screenshot depicting an exemplary user interface in accordance with an embodiment of the present invention, designated generally as 600. The specific heading 610 shown in FIG. 6 is “category name,” indicating categories 612 of design requirements 134 are displayed in exemplary user interface 600. Design requirement categories 612 in this example include categories 612 such as dimensions, lighting, and acoustics, and may include heading 610 in one embodiment.

In an embodiment of the present invention, categories 612 are design requirements. Edit option 614 and delete option 616 are presented in an embodiment. An add category option 618 is directed to adding a category of design requirements in field 620. Add category option 618 may be selected to access field 620 in one embodiment, or it may be selected to transmit or ultimately store a new category of requirements. In an example, field 622 receives input related to the sort order of a new category.

Categories of design requirements 612 may be created, added, renamed, or modified by multiple users. This is in contrast to static categories of design requirements, which may be determined at an early time or only determined once (or a limited number of times) during the initial programming process. This is also in contrast to categories of design requirements that are added or modified by certain users or certain devices. The flexible aspects of database 124 and the textual input of categories 612 facilitate the ability to add and define categories 612 in embodiments of the present invention.

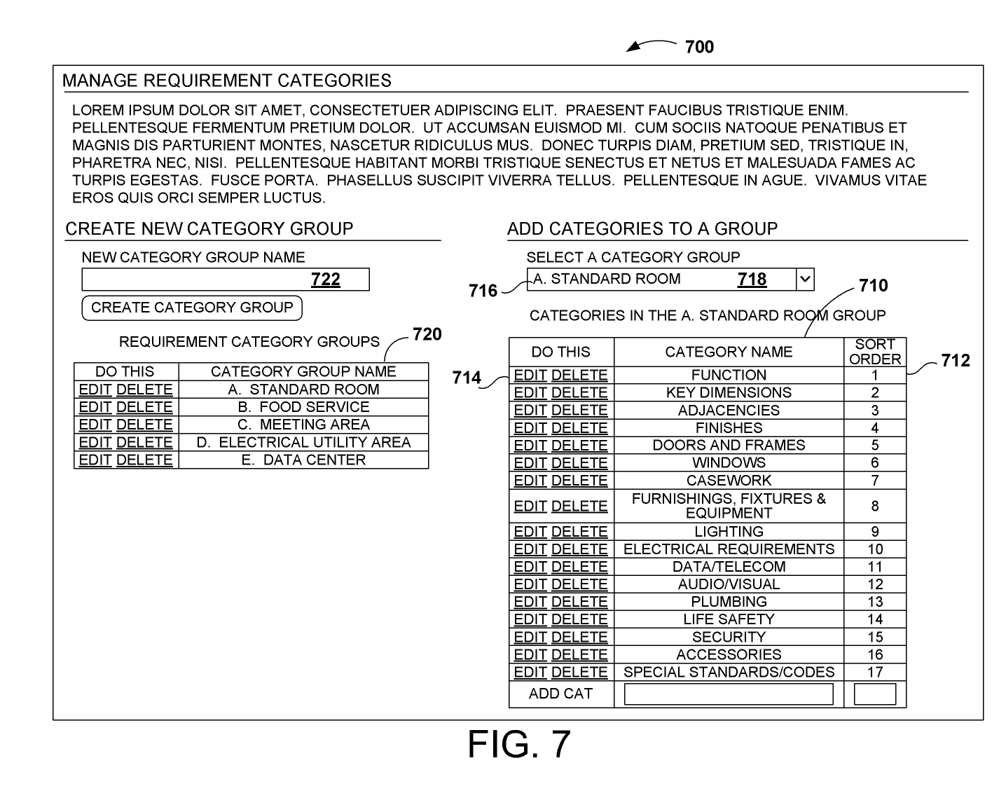

Turning now to FIG. 7, an interface depicting a list of requirement categories in accordance with an embodiment of the present invention is designated generally as 700, including categories 710. The example in FIG. 7 includes categories of design requirements 710 such as dimensions, windows, and security. In an embodiment of the present invention, categories 710 are design requirements at a certain level in a hierarchy, either in a database 124 or in a display of information. Categories 710 are sorted in FIG. 7 as shown by sort order 712. Each category 710 is presented with an option 714 to edit or delete category 710 in one embodiment, and categories may be added in an embodiment.

In the exemplary view 700 shown in FIG. 7, categories 710 are displayed based on selection 716. Selection 716 represents a design requirement associated with categories 710 in FIG. 7. In one embodiment of the present invention, selection 716 is from a drop-down menu 718 including available requirements for selection. In FIG. 7, list 720 may correspond to the drop-down menu 718 options. A new option for menu 718 and/or requirement for list 720 is added at field 722 in an exemplary embodiment.

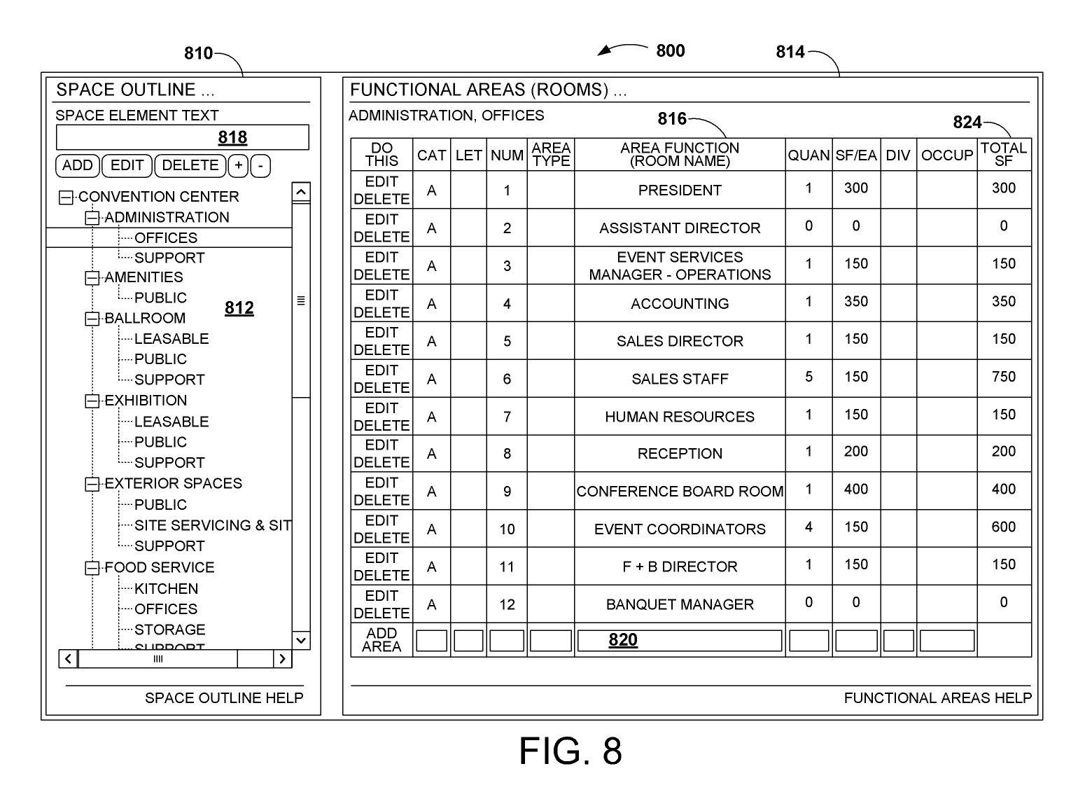

Turning to FIG. 8, an exemplary user interface view in accordance with an embodiment of the present invention is depicted and designated generally as 800. Section 810 of view 800 includes design requirements 812, including office and storage spaces. The specific examples of design requirements 812 indicate physical areas or locations. Section 814 includes design requirements 816. The specific examples of design requirements 816 in FIG. 8 indicate planned uses of spaces. Planned uses may be described as, or based on, occupants or users of spaces, such as “Assistant Director.”

As shown in an embodiment in FIG. 8, additional design requirements may be added in fields 818 and 820. In one embodiment, additional requirements input into field 818 relate to physical attributes or areas, while additional requirements input into field 820 relate to planned uses. Design requirements may be changed or removed through option 822. FIG. 8, in one embodiment, includes a set of design requirements, such as square footage, displayed in association with design requirements 816. Embodiments of the present invention aggregate square-footage values for projects or portions of projects. For example, the square footage for multiple rooms in one level of a hierarchy may totaled and displayed in association with that level. In an embodiment, the present invention applies multiple grossing factors. Grossing factors are used to increase one type of square-footage values to accommodate additional spaces, for example walls and mechanical spaces, such as circulation shafts. Embodiments of the present invention enable separate grossing factors for different portions of project 132. For example, in an embodiment, a campus may include a theatre with a higher grossing factor than a classroom, and the present invention is able to apply both grossing factors to determine square footages or total square footage.

FIG. 9 depicts an exemplary user interface in accordance with an embodiment of the present invention, generally shown as 900. User interface 900 includes portion 910 and design requirements 912. Design requirements 912 are displayed in a hierarchal arrangement. In the specific example shown in FIG. 9, design requirements 912 are organized in a hierarchy based on planned uses of areas indicated by metadata. In an embodiment, when users contributed design requirements 912, the requirements 912 were associated with configurable metadata in order to determine relationships among requirements 912 in an extensible database 124. Metadata may trigger new fields or entries in a database 124 and may organize the display of requirements 912 to users.

As shown in FIG. 9, portion 914 includes design requirement 916. In the example shown, design requirement 916 is embedded with design requirements 912 in portion 910, but not displayed in portion 910. In embodiments of the present invention, portion 914 presents data from a different hierarchal level of database 124 than portion 910. For example, portion 914 shows a more detailed design requirement related to a ballroom than requirements 912 in portion 910, but design requirement 916 may be included within one of the design requirements 912.

Design requirement 916 in FIG. 9 includes user information 918. In one embodiment, user information 918 identifies the user that contributed requirement 916 to another user. Embodiments of the present invention use user information 918 as metadata to determine storage in a database 124. Although an example is displayed in FIG. 9, metadata may be determined and used without being visible to users. Metadata may be inherently determined based on input fields, users, time stamps, or other manipulations of data by users, such as moving information from one location to another. Option 920 allows a user to direct printing of requirements from user interface 900, in some cases by selecting a link.

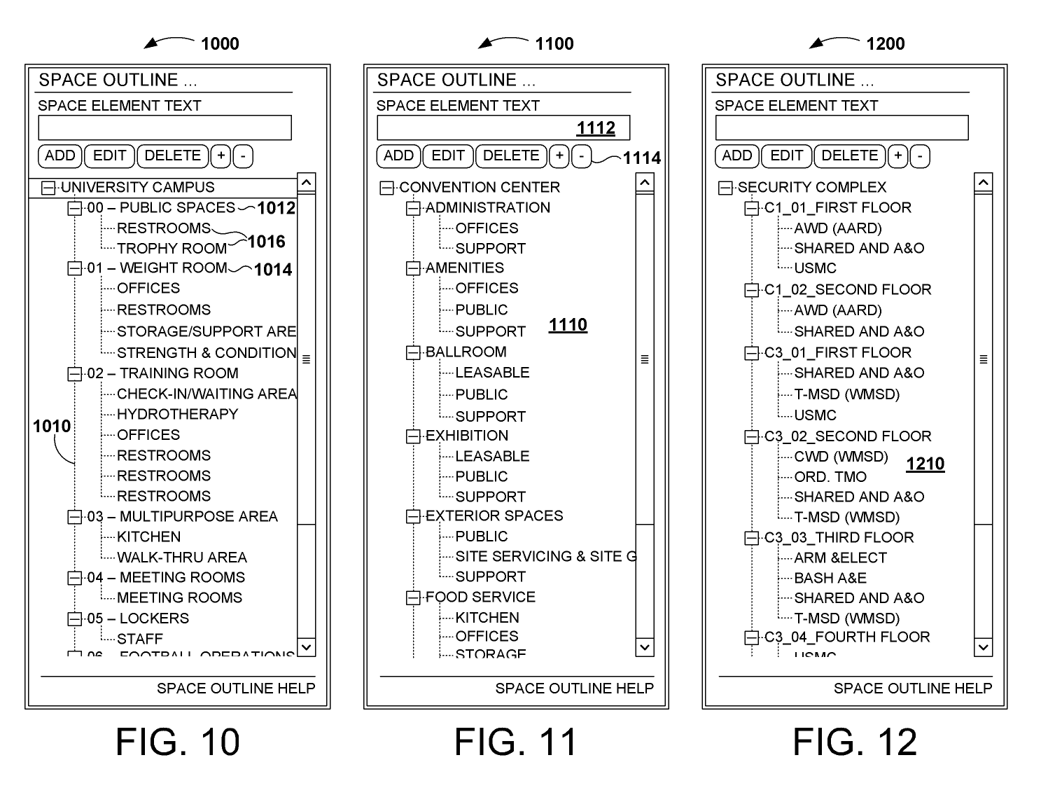

Turning next to FIGS. 10, 11 and 12, exemplary embodiments of views of design requirements are shown, designated generally as 1000, 1100, and 1200, respectively. Turning to FIG. 10 in particular, view 1000 shows requirements 1010 in an embodiment related to a university campus. As shown, design requirements 1010 include training and weight rooms, restrooms, and public spaces. Specifically, a first design requirement 1012 indicates a university building will be constructed in accordance with including public spaces. Design requirement 1014 is associated with the same level in a data structure as design requirement 1012 in one example of an embodiment of the present invention.

In FIG. 10, set of requirements 1016 includes restrooms and trophy room in an embodiment. Set of requirements 1016 is shown on a hierarchical level below requirements 1012, meaning, in one example, that public spaces 1012 of the university will include restrooms and trophy room 1016. Requirements 1016 may share or have in common metadata indicating their relationship to requirement 1012 and/or each other in embodiments of the present invention.

Metadata may or may not be indicated in view 1000, although it may be configured by a user based on actions with respect to view 1000. Configuration of metadata adds to or changes a data structure, for example, a data structure such as the example in FIG. 3, in an embodiment of the present invention. This allows users to perform actions that generally require creation of new code by a user, as opposed to automatic changes in embodiments of the present invention.

Turning to FIG. 11, an exemplary embodiment of a view in accordance with the present invention is designated generally as 1100. In the example shown in FIG. 11, a project involves design requirements 1110 regarding a convention center, such as exterior spaces and food-service areas. Multiple levels of requirements 1110 are displayed in view 1100, and requirements may be added to any level through input area 1112. In an embodiment, a user enters text into area 1112 and selects to add the text as a requirement 1110 through options 1114. In an embodiment, a user selects an existing design requirement from requirements 1110, then selects to edit or delete the requirement through options 1114.

In an embodiment, a level of requirements 1110 is selected by a user. Text is entered into area 1112. When a user selects to add the text as a requirement through options 1114, application 122 directs the text in area 1112 to database 124, including metadata based on the level selected by the user. In an embodiment, metadata indicating the user is included. Database 124 expands appropriately and stores relationships based on the metadata in an embodiment of the present invention. Options 1114 may allow users to move design requirements 1110 by making one selection, thereby affecting relationships in database 124.

FIG. 12 illustrates an exemplary view, 1200, in accordance with an embodiment of the present invention. In a specific example shown in FIG. 12, design requirements 1210 are associated with construction of a security complex, such as buildings and floors and whether spaces will be shared. In one embodiment, metadata enables association of design requirements 1210 by (and including) floors. In this example, data are displayed or stored in accordance with metadata, and the characteristic indicated by metadata may be directly displayed for configuration by users. In other words, aspects of design requirements indicating relationships with other design requirements may be viewed and manipulated in embodiments of the present invention.

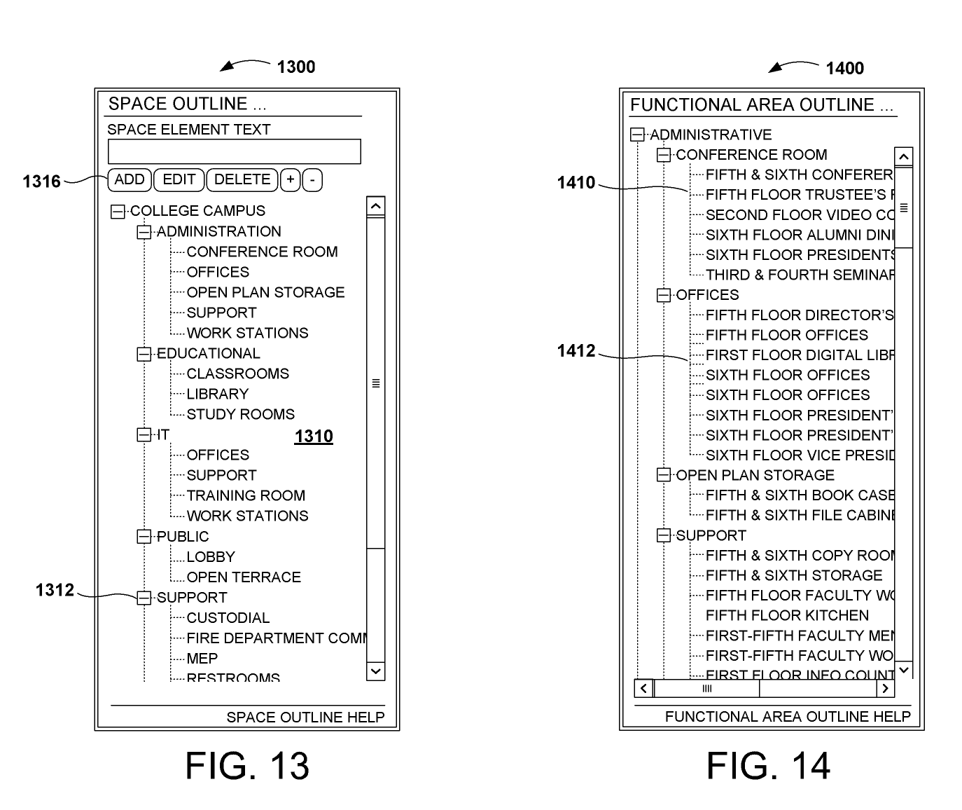

FIG. 13 shows an exemplary view in accordance with the present invention, designated generally as 1300. In the specific example shown in view 1300, design requirements 1310 include spaces, such as “Public” and “Open Plan Storage,” a college will be constructed in accordance with. Aspects of this view are expandable or collapsible through selection of icon 1312, and requirements or edits to requirements may be input in field 1314. In an embodiment, requirements 1310 may be added, changed or removed with the aid of options 1316.

Turning to FIG. 14, an illustrative view in accordance with an embodiment of the present invention is shown generally as 1400. The view 1400 in FIG. 14 may relate to the same requirements shown in FIG. 13. In an embodiment shown in FIG. 14, design requirements 1410 relate to a planned purpose for an area, such as conference rooms. The same design requirement may be grouped with one set of requirements in one embodiment of a view and grouped with a second set of requirements 1412 in another embodiment of a view (such as offices in FIGS. 13 and 14).

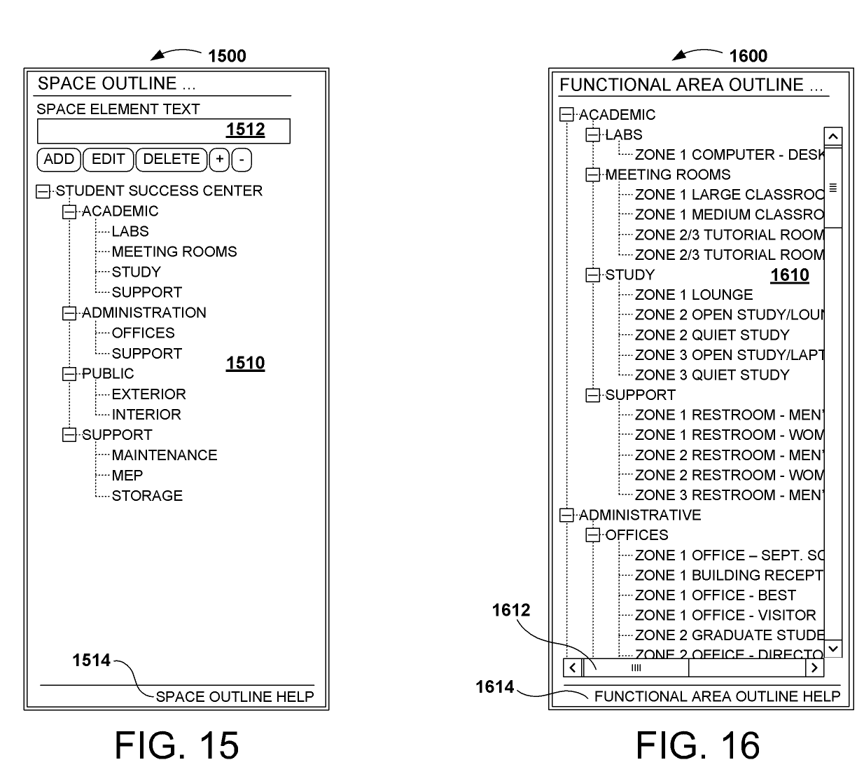

FIG. 15 shows an exemplary outline designated as 1500, including design requirements 1510. In the example in FIG. 15, a student center includes requirements 1510 regarding academic spaces, such as laboratories, and public spaces, such as an exterior. New requirements may be input at field 1512, and support may be accessed by selecting help option 1514.

Turning to FIG. 16, an illustrative view of design requirements 1610 according to the present invention is shown generally as 1600. In the specific example in FIG. 16, design requirement data is presented based on functions and zones of areas 1610. View 1600 extends vertically and horizontally through use of scroll features 1612. A request for help can be received through link 1614.

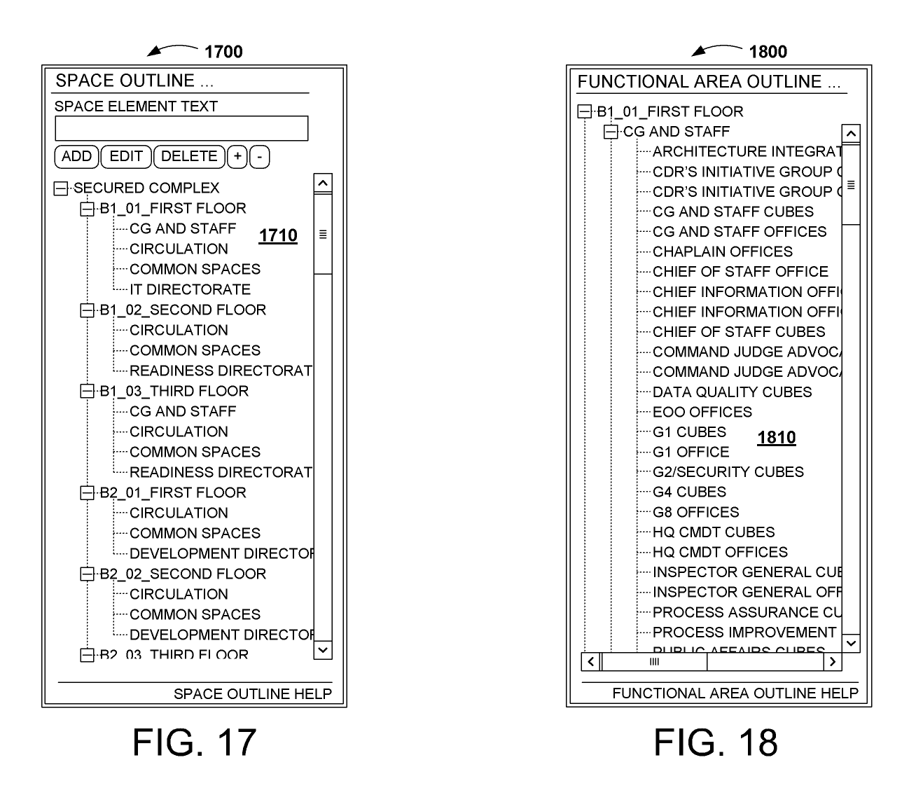

As shown in FIG. 17, an illustrative view of an embodiment is designated generally as 1700. View 1700 includes design requirements 1710 organized by floors of a physical structure to be built. An embodiment shown in FIG. 18, designated generally as 1800, includes design requirements 1810, such as first floor and a department of employees. In an embodiment, the requirements 1810 in FIG. 18 are a more detailed view of requirements 1710 in FIG. 17, or an expanded view of requirements 1710, after selection of requirement(s) 1710 by a user.

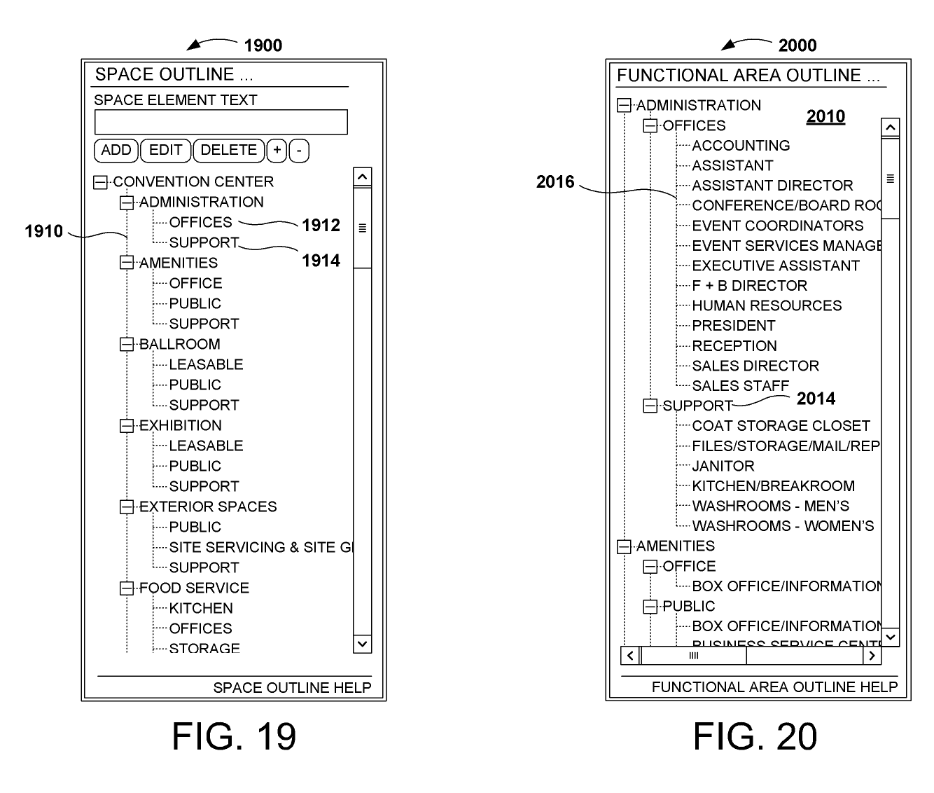

Turning now to FIGS. 19 and 20, exemplary views in accordance with embodiments of the present invention are shown and designated generally as 1900 and 2000, respectively. In an embodiment shown in FIG. 19, requirements 1910 include design requirements 1912, 1914 (“Offices,” “Support”). Turning now to an embodiment in FIG. 20, exemplary view 2000 includes design requirements 2012, 2014 (“Offices,” “Support”). Design requirements 2010 shown in FIG. 20 include design requirements 1910 from FIG. 19. Additional requirements at a different level of detail, such as requirements 2016, may be displayed while preserving a view, or providing a modified view, of originally viewed requirements, such as the display of requirements 1910 from FIG. 19 within view 2000 in FIG. 20. In an embodiment, requirements 1910 are modified, explained, or commented on by additional requirements 2016 shown in FIG. 20.

Embodiments of the present invention include any number of users. Individual users of remote computing devices, for example devices 110 through 118 in FIG. 1, can be identified as associated with a single project or multiple projects. In an embodiment, users must be associated with a project in order to view or contribute design requirements. In some cases, devices 110 through 118 capable of contributing design requirements can be recognized or authenticated, or a secure connection may be verified.

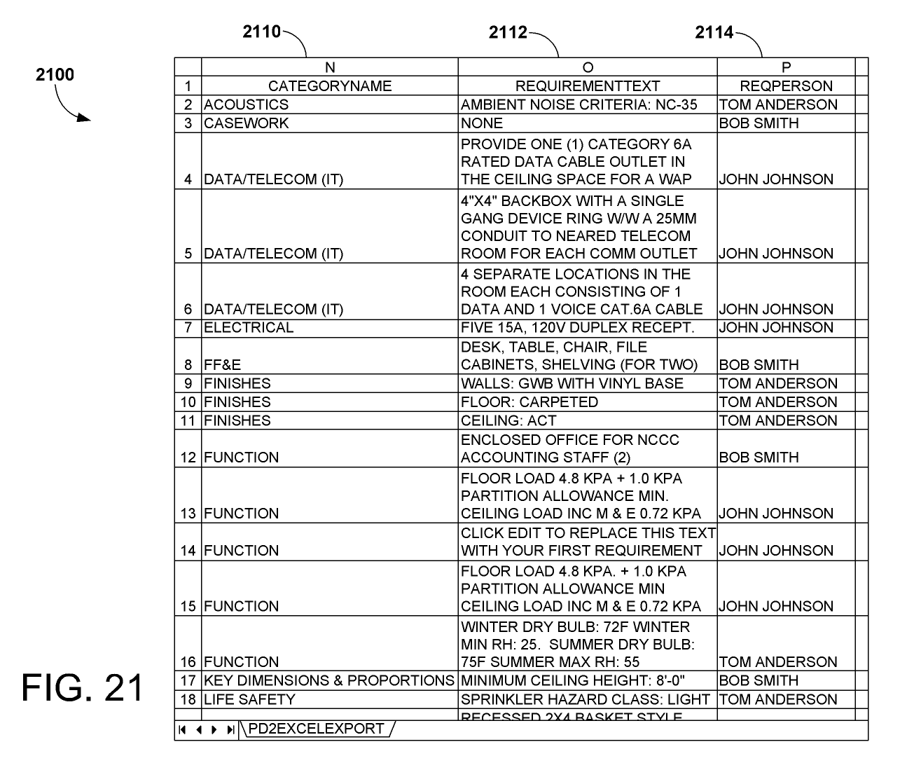

Turning now to FIG. 21, an exemplary view depicting requirements in accordance with an embodiment of the present invention is shown generally as 2100. Embodiments of the present invention enable viewing design requirements, comments regarding requirements, and/or changes to requirements and comments. Requirements and/or changes may be viewed according to individual users or a subset of users. In a specific example, John Johnson is one user associated with a project that has contributed requirements that a physical structure is to be made consistent with. Contributions by John Johnson are viewable by other users and manageable in embodiments of the present invention.

In the specific example shown in FIG. 21, view 2100 includes design requirements stored as categories 2110 and textual requirements 2112. One or more users 2114 are shown, including John Johnson, in FIG. 21. In an embodiment, users 2114 are associated with design requirements 2110, 2112, by, for example, entering or changing textual requirements 2112. Because embodiments of the present invention archive data and user information, view 2100 is able to present requirements 2110, 2112 according to contribution information, such as users 2114 and time periods. The data and view represented generally in 2100 are scalable at each level to accommodate additional users 2114 and requirements 2110, 2112. In one embodiment, view 2100 is a view of data intended for export to another application or program. In another embodiment, view 2100 shows data received from another application.

Data stored or received in accordance with embodiments of the present invention can be exported. Some or all of the data in database 124 may be exported. For example, requirements, such as requirement 134, may be extracted or processed for transmission to another device, program, or application. Data for export are selected based on spaces, such as areas of a building, in one embodiment. Design requirements for one room, such as a bathroom, may be exported in an embodiment. Contributions from certain user(s), for example one or more team leaders, are selected for exportation in another embodiment. In some cases, design requirements, including comments and changes to requirements, from a time period are exported. Other query parameters govern the data selected to be exported in embodiments of the present invention.

Data can be presented to a remote computing device, including devices 110 through 118 or another device. Exportation of data is to a software application in embodiments of the present invention. In one embodiment, design requirements, and, in some cases, metadata, stored in database 124 are exported to a word-processing application, such as Microsoft® Word. In another embodiment, data is exported to a spreadsheet application, for example, Microsoft® Excel. Other examples of destinations for design requirements include users via a distribution list or electronic mail, other databases, or query responses. Use of textual requirements 134 facilitates exportation.

Embodiments of the present invention include exporting data stored in database 124 to an application programming interface (API) for further use. In one embodiment, data may be used as input for building information modeling software, such as Autodesk Revit®. Data may be exported or shared for use with computer-aided drafting (CAD) software using systems, such as Onuma Planning Systems (OPS) or Construction Operations Building Information Exchange (COBIE) systems. In embodiments, data are exported using or into a particular file type. The file type facilitates use of the data in an embodiment. As specific examples, Industry Foundation Classes (IFC) compliant files, .NET, and .ASPX files may be used.

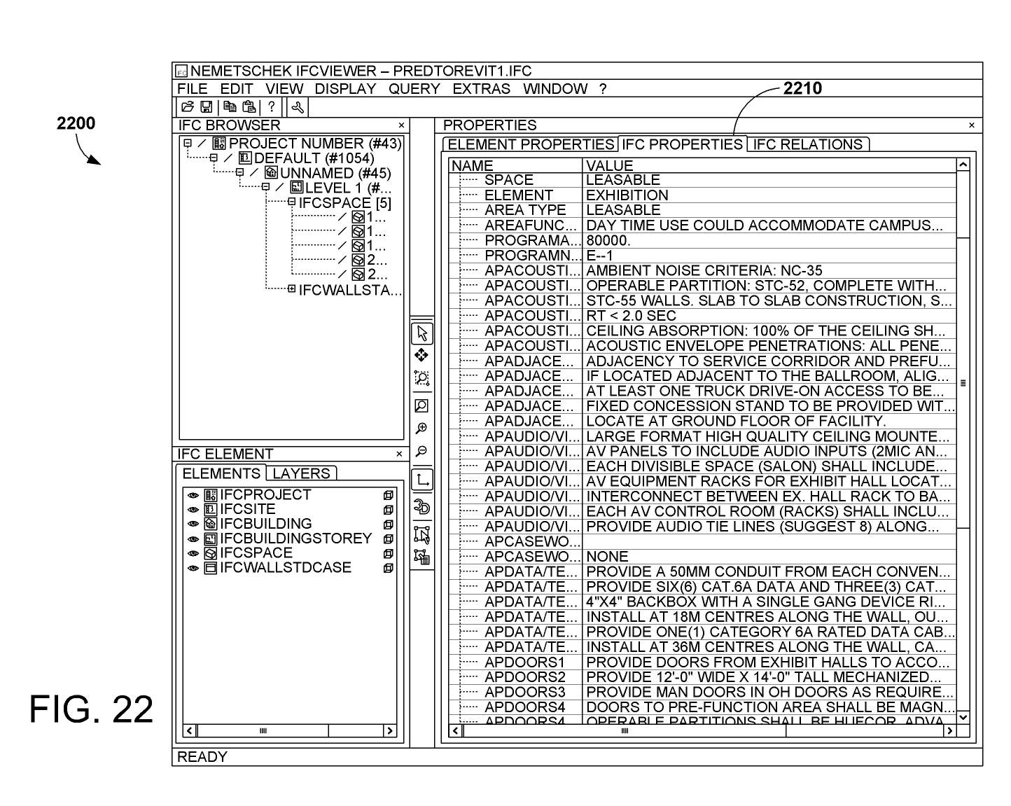

FIG. 22 is an exemplary screen view in accordance with an embodiment of the present invention, designated generally as 2200. In the example in FIG. 22, view 2200 shows received design requirements 2210 at another program or software, such as building information modeling software. In embodiments of the present invention, additional information associated with design requirements 134 is also exported from database 124 or user devices 110 through 118 into an application or program.

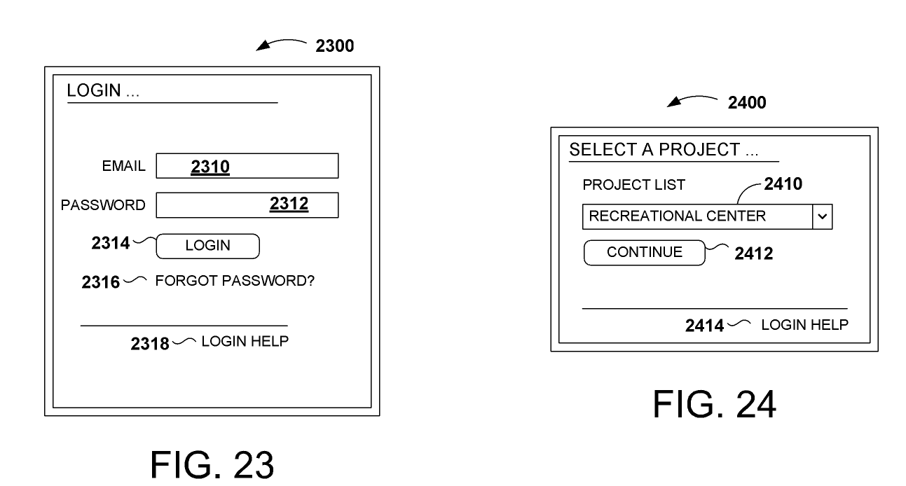

Turning now to FIG. 23, an exemplary view in accordance with an embodiment of the present invention is shown generally as 2300. Users of devices 110 through 118 each identify themselves, such as through interface 126 on device 110, in an embodiment of the present invention. Embodiments include automatically accessing application 122 based on certain criteria, such as the devices 110 through 118 used, or software. In the specific example shown in FIG. 23, first user information is input into field 2310 and second user information is input into 2312, to establish a certain user is using a remote computing device. In an embodiment, option 2314 is selected to submit user information.

In some cases, information is only inputed into either field 2310 or 2312, such as, for example, inputting information into area 2310 but not area 2312. Users may select option 2316 in cases where both pieces of information are not readily available or known. In addition to using one piece of information to obtain or bypass logon requirements, such as not knowing a password, in embodiments, assistance may be accessed through option 2318 in an embodiment shown in FIG. 23.

FIG. 24 is an exemplary view in accordance with an embodiment of the present invention, designated generally as 2400. In the example shown in FIG. 24, a project is selected at 2410. Although a menu is shown at 2410, in other embodiments, a list is displayed, including links in an embodiment. Users indicate a project is selected at 2412. Assistance is accessible through option 2414. In some cases, a user may be associated with one project and bypass this page automatically.

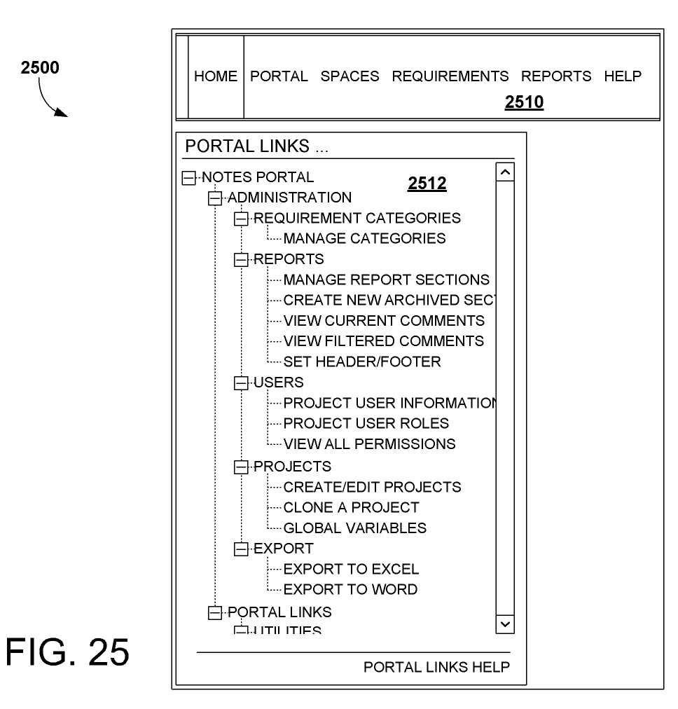

FIG. 25 illustrates an exemplary interface view in accordance with an embodiment of the present invention, designated generally as 2500. The illustrative view 2500 shown in FIG. 25 is one example of a portal used to access or select user actions. Section 2510 includes selections to change the 2500 view or navigate aspects of project 132, including returning to a home page view in an embodiment. Section 2512 displays view and/or action options for users. In the specific example shown in FIG. 25, a expandable menu is shown in section 2512, including options in this specific embodiments such as managing user access, such as by managing roles and permissions or configuration information, managing design requirements 134, creating a resource 130, viewing users or projects and exporting information from database 124.

Options in section 2512 are displayed in a hierarchy in an embodiment, with potential user actions in section 2512 grouped according to aspects of project 134. In an embodiment, view 2500 in FIG. 25 indicates only user options available to an identified user. In another embodiment, all options are viewable in section 2512, including options a user may not have rights to perform, discussed below.

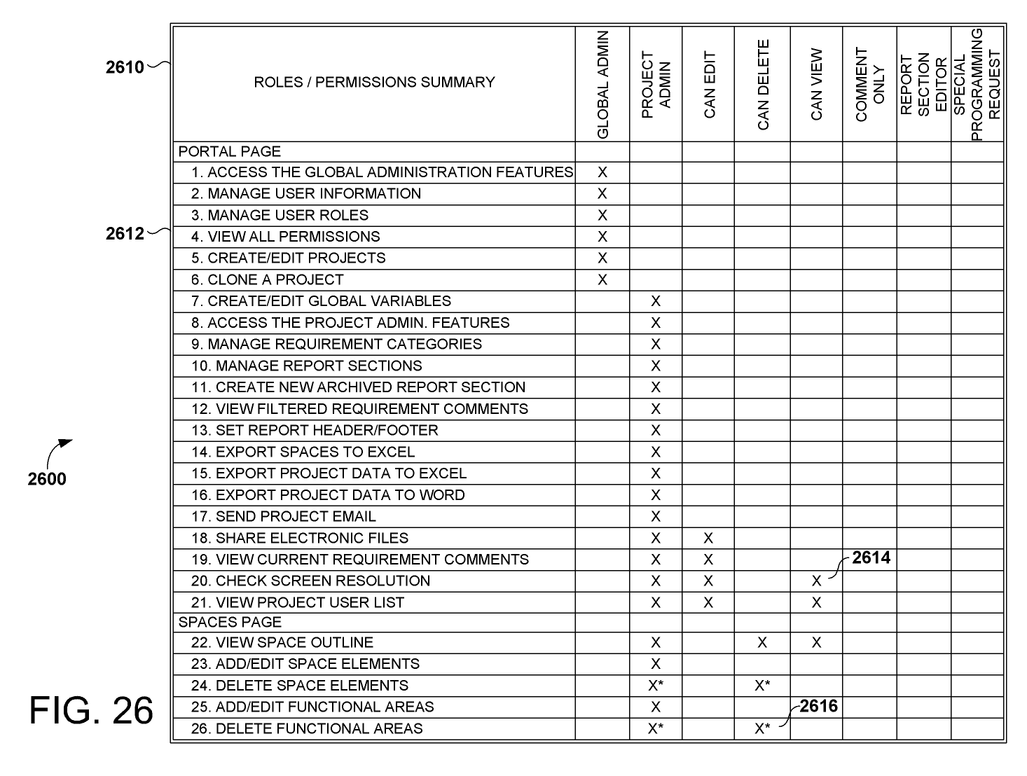

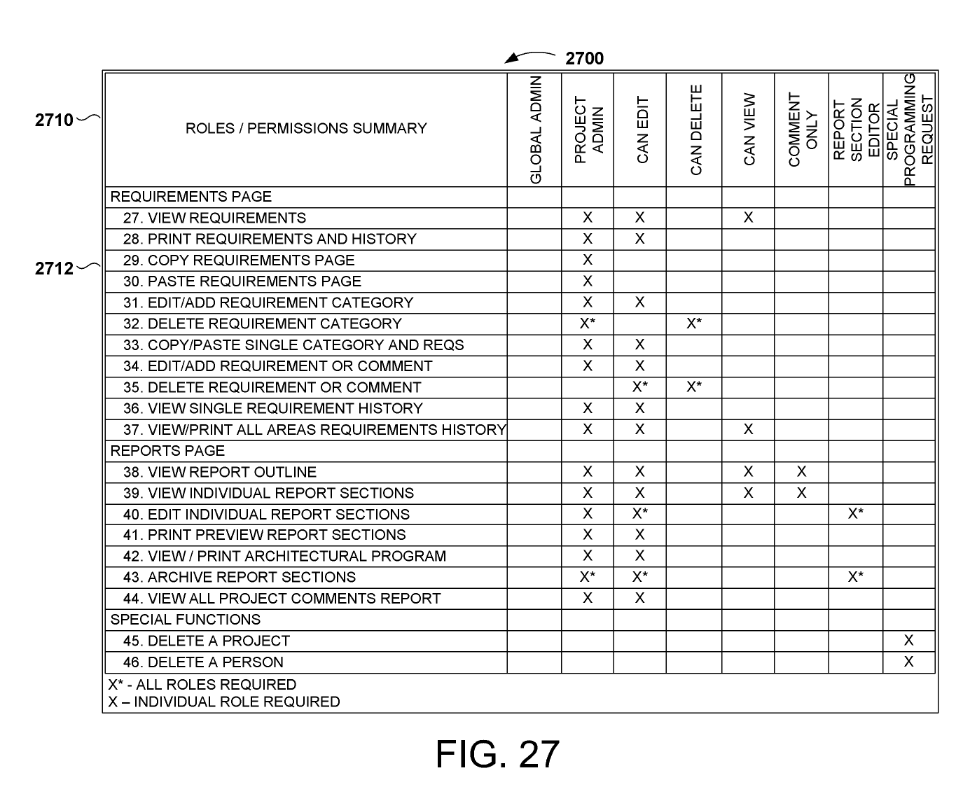

Turning next to FIGS. 26 and 27, illustrative views of an exemplary list or roles in accordance with an embodiment of the present invention, designated generally as 2600 and 2700, respectively. FIG. 26 includes section 2610 displaying examples of potential user roles. Section 2612 displays examples of rights or permissions associated with the user roles in Section 2610, established by an administrator in an embodiment. The specific roles in 2610 and permissions in 2612 are for illustration purposes only. Roles and permissions may be customized or changed during projects in an embodiment of the present invention. Permissions in section 2612 may be grouped by views or pages in an embodiment, as shown in the example in FIG. 26 with respect to portal page permissions in section 2612. Indication 2614 (“X” in FIG. 26) indicates permissions in 2612 requiring an individual role in one embodiment of the present invention, while indication 2616 (“X*” in FIG. 26) indicates all roles are required for a permission. Turning to FIG. 27, other examples of roles are shown in section 2710, and further examples of specific permissions are shown in section 2712. As discussed with respect to FIG. 26, the user roles and permissions listed are by way of example only.

Embodiments of the present invention enable electronic messages directly between users, such as users of devices 110 through 118. In an embodiment, the electronic messages are sent without necessarily logging in to a another program or accessing another server. In an embodiment, server 120 facilitates electronic messages between users. This allows current user information to be detected prior to transmitting an electronic messaging systems. For example, as opposed to some conventional electronic messages, embodiments of the present invention allow group electronic messages sent only to users currently connected to the system or logged into a project. In other embodiments, electronic messages are sent to all relevant users regardless of their status and stored for review.

In embodiments of the present invention, all contributed data is stored. In some cases, electronic mail can be used to avoid permanent storage of information or to broadcast information about a project to all users. For example, a user may have a message for other users that is not relevant to design aspects of a project 132. An electronic message can be generated to communicate with other users without affecting the historical information relevant to design considerations. In alternative embodiments, electronic messages may be stored and associated with project 132, the sending or receiving users, or certain design requirements. In these cases, messages are added to the database 124, potentially based on metadata indicating a project 132 or user(s).

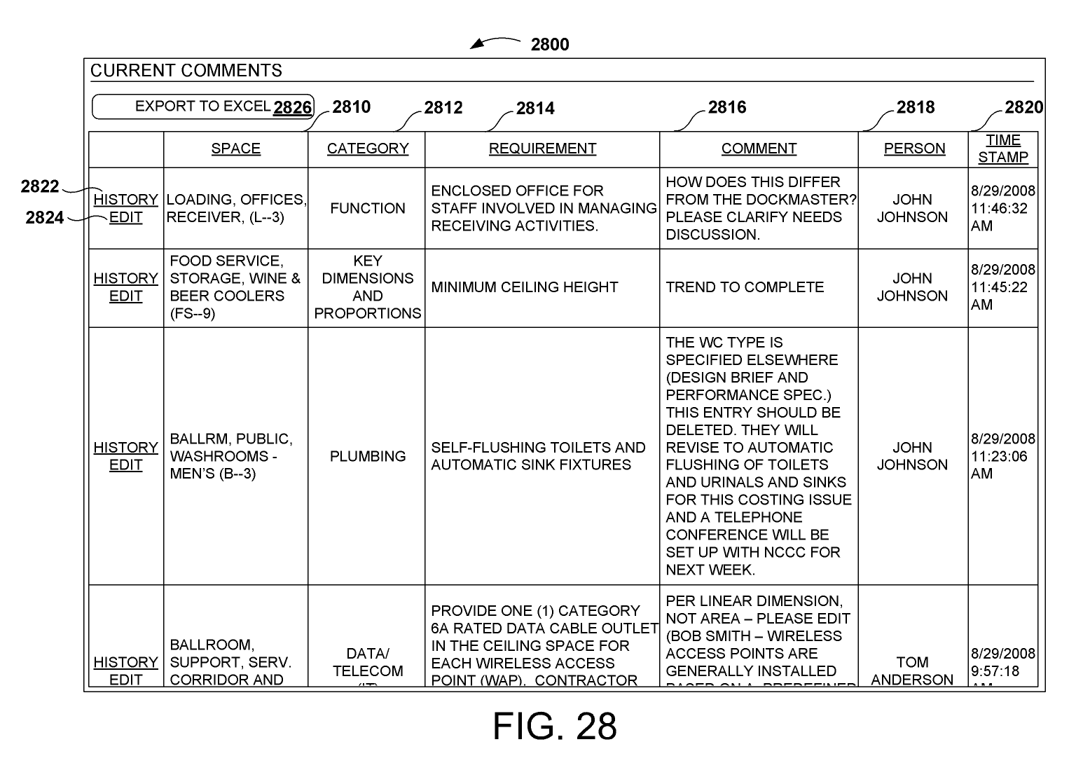

Turning now to FIG. 28, an illustrative depiction in accordance with an embodiment of the present invention is shown and designated generally as 2800. Design requirements are displayed in sections 2810, 2812, and 2814. In one embodiment, sections 2810 through 2814 each include design requirements from unique levels of a hierarchy. Comments are displayed in section 2816. In an embodiment of the present invention, comments that need further attention or review are displayed. This allows a user of device 110 to view outstanding comments from all users in one embodiment.

In a specific example, comments in 2816 are outstanding comments where metadata is used to determine the status of comments. In another example, users may directly input data indicating comments in 2816 require further review. Another embodiment includes comments in 2816 as outstanding until users indicate they have been addressed or satisfied.

In the exemplary view 2800 shown in FIG. 28, users associated with comments in 2816 are displayed in section 2818. Data indicating a point in time associated with comments, requirements, or changes may be included, as shown in section 2820. Links may provide the option to sort or organize data shown in view 2800 according to data in each section 2810 through 2820. An embodiment shown in FIG. 28 enables viewing recent comments or comments from certain user(s). User access can be established to allow editing and commenting, or commenting only.

Continuing with respect to FIG. 28, option 2822 provides a user with a historical view of a requirement and associated comments, including additional associated design requirements from other levels of a hierarchy, which may be embedded and not visible or shown in sections 2812 and 2814 in an embodiment of the present invention. Option 2824 is selected to enable edits in an embodiment. Some or all of the data in view 2800 may be prepared for or transmitted to an application, such as a spreadsheet application, by selecting option 2826.

Turning next to FIG. 29, an illustrative view depicting an interface in accordance with an embodiment of the present invention is shown generally as 2900. View 2900 shows an example of an outline of a resource 130 including design requirements. FIG. 29 includes exemplary sections 2910, indicating resource 130 will include sections 2910, such as requirements, in an embodiment. View 2900 of sections 2910 is collapsible and expandable in embodiments of the present invention. Data may be selected from database 124 for inclusion in various sections 2910. Levels in a data structure correspond to one or more sections 2910, according to an embodiment of the present invention.

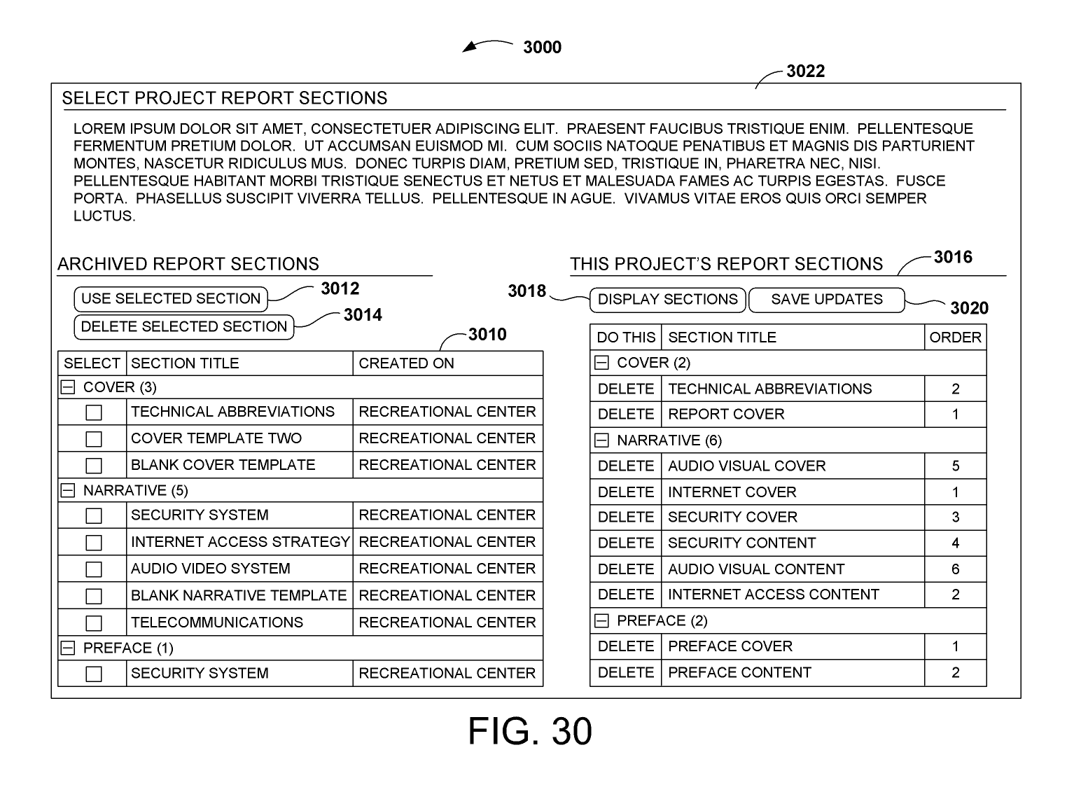

Turning now to FIG. 30, an exemplary screen shot depicting a user interface in accordance with an embodiment of the present invention is shown, designated generally as 3000. Stored sections 3010 are displayed in the example in FIG. 30. By storing contributed data from users, an embodiment of the present invention is able to display sections 3010 associated with a present project or another project(s). Stored sections 3010 were not necessarily included in resource 130, nor even intended for inclusion in resource 130, such as templates, in an embodiment.

Stored sections 3010, including templates, are selectable and usable in resource 130 through option 3012, in an embodiment shown in FIG. 30. Option 3014 enables removal of sections 3010. The exemplary embodiment in FIG. 30 includes source information as part of stored sections 3010, such as “Recreational Center,” which indicates a stored project 132 or design requirement 134 in an embodiment.

Sections 3016 represent sections currently selected for inclusion in resource 130 according to an embodiment of the present invention. Option 3018 in FIG. 30 changes the display in FIG. 30 to include additional information regarding sections 3016. In an embodiment, selection of option 3018 directs a user to the section represented in 3016, where a user may make changes or copy data. Option 3020 directs storage of changes to present sections 3016, including embodiments where 3020 causes storage of changes to information shown in 3016 and embodiments where 3020 causes storage of changes to information included or embedded in sections 3016 but not displayed in FIG. 30.

Stored sections 3010 and present sections 3016 are presented in hierarchal arrangements in exemplary user interface 3000 that may be individually expanded or collapsed. In the specific example in FIG. 30, instruction area 3022 provides information for a user regarding sections 3010, 3016. The text in area 3022 is a message or possible instructions used in embodiments of the present invention.

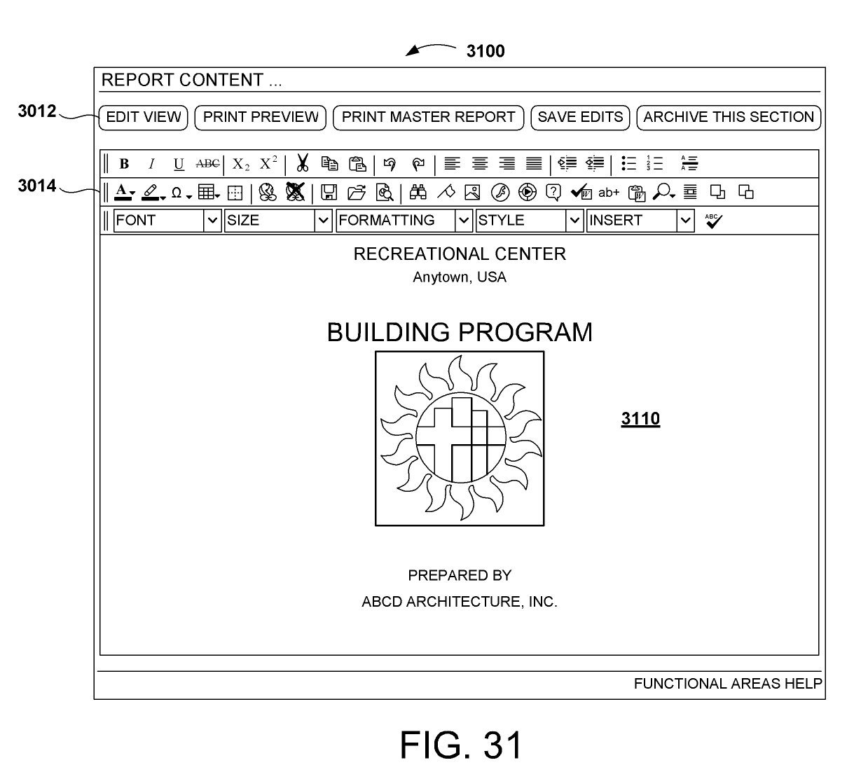

Turning to FIG. 31, an exemplary view of an interface in accordance with an embodiment of the present invention is shown generally as 3100. FIG. 31 illustrates view 3110 of resource 130 in an embodiment. The view 3110 in FIG. 31 only includes one or more sections for potential inclusion in resource 130 in an embodiment. In embodiments of the present invention, sections for potential inclusion in resource 130 are stored in database 124 or at remote computing devices 110 through 118. View 3110 is a preview of sections for use in resource 130 in one example.

Exemplary interface view 3100 includes section 3112, displaying options for potential resource sections such as printing, saving changes, and archiving. Section 3114 displays options for presentation of sections of a resource 130. Examples of options in section 3114 include options used in word-processing applications, such as controlling the format and performing editing functions. In one specific example, options in 3114 are displayed or accessible based on selection of an option in section 3112, such as “Edit.”

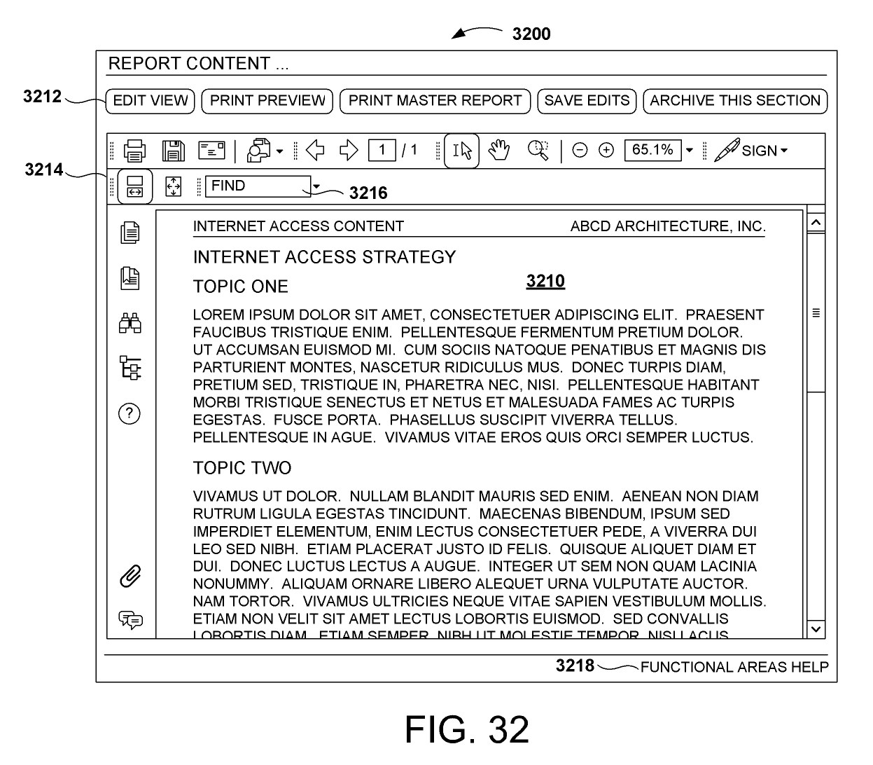

Next turning to FIG. 32, an exemplary view of an interface according to an embodiment of the present invention is shown, designated generally as 3200. Resource portion 3210 is presented for view in FIG. 32. Portion 3210 is intended for eventual inclusion in resource 130 in an embodiment. In another embodiment, portion 3210 is a template or a version of a stored section used to create resource 130.

Section 3212 of the example shown in FIG. 32 includes selectable choices for users, including choices such as previewing a print version and printing a master report in an embodiment. Section 3214 of FIG. 32 includes selectable choices, including search field 3216 and a digital signature option. In one specific embodiment of the present invention, section 3212 includes choices related to data manipulation or the view shown on user interface 126, while section 3214 includes choices related to the view or formatting of resource 130.

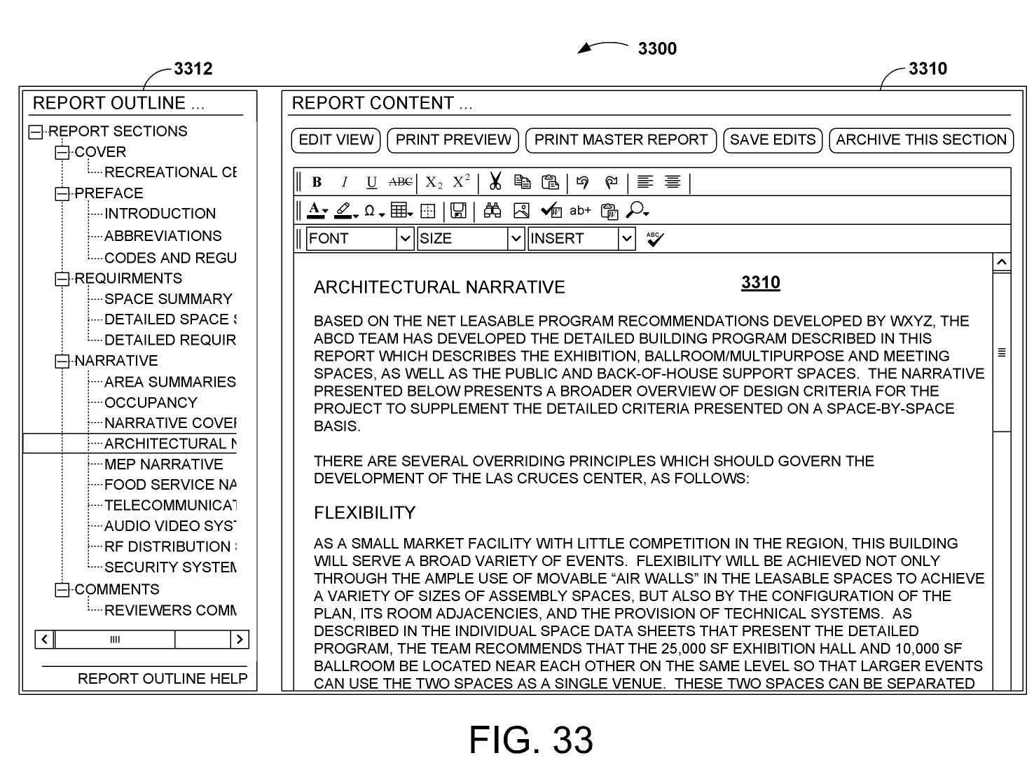

Turning now to FIG. 33, an illustrative view in accordance with an embodiment of the present invention is shown and designated generally as 3300. As shown in FIG. 33, embodiments of the present invention allow users to view a preview in section 3310 and an outline in another section, 3212. Two sections 3310, 3312 in an embodiment enable a user to make formatting or other changes to resource 130 in section 3310 or to navigate resource 130 through selections in section 3312, which may be expandable in an embodiment. FIG. 33 includes an exemplary view of a narrative section 3314 of resource 130 in section 3310. Narrative 3314 may be a free-form text document incorporating design requirements 134 or explaining systems with or without reference to a hierarchical structure of requirements. The word processing features within web-based browser 128 permit formatting of narrative 3314, including tables, diagrams or graphs. Narrative 3314 is a flexible, unrestricted section of resource 130 in an embodiment.

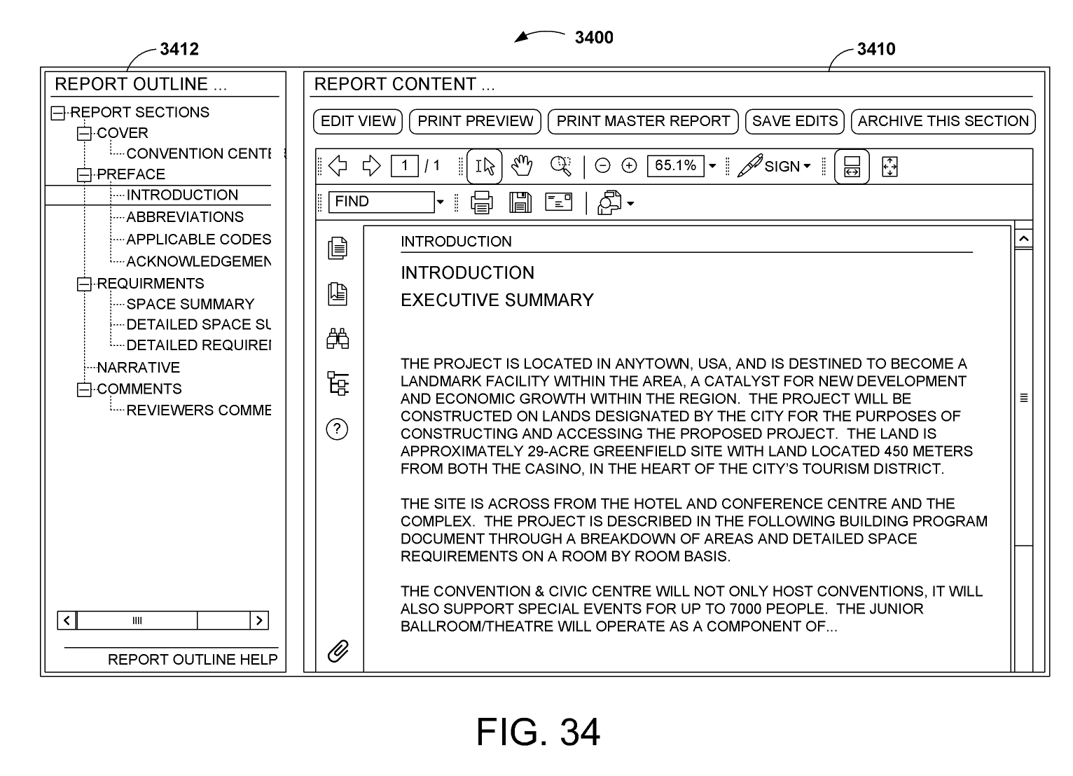

Turning to FIG. 34, an exemplary user interface view in accordance with an embodiment of the present invention is designated generally as 3400. FIG. 34, like FIG. 33, demonstrates a section (3410) with a view (or preview) of resource 130 and a section (3412) with an outline of resource 130. Aspects of the outline in section 3412 may be selected to navigate the view in section 3410. The specific example in FIG. 34 includes an executive summary for potential inclusion in resource 130.

Option 3218 provides access to assistance with features of embodiments of the present invention. Although various depictions in the accompanying figures label help options, such as option 3218, as certain types of assistance, the specific labels used in exemplary figures are not intended to limit the type of help available through selection of help options in embodiments of the present invention. In fact, the help option available is dynamic based on the view, a portion of the view, or the present selection in an embodiment. In general, help options, such as option 3218 in FIG. 32, direct users to relevant assistance or instructions, or to views capable of receiving questions, in embodiments of the present invention.

Users, based on roles and/or permissions, may take the actions with respect to data in one exemplary embodiment of the present invention. These actions may include managing design requirements 124 by adding requirements, including categories of requirements 124, or copying, viewing (including historical data), updating and deleting requirements 124. Administrative actions may include managing requirements 124, resources or reports 130. Additional administrative actions include managing users, projects 132, establishing global variables, data export and electronic messages, including accounts and settings, in an embodiment. User actions may include managing one or more resources 130 at any phase of development of resource 130 in an embodiment of the present invention, including saving, changing, printing and archiving some or all resource 130 sections.

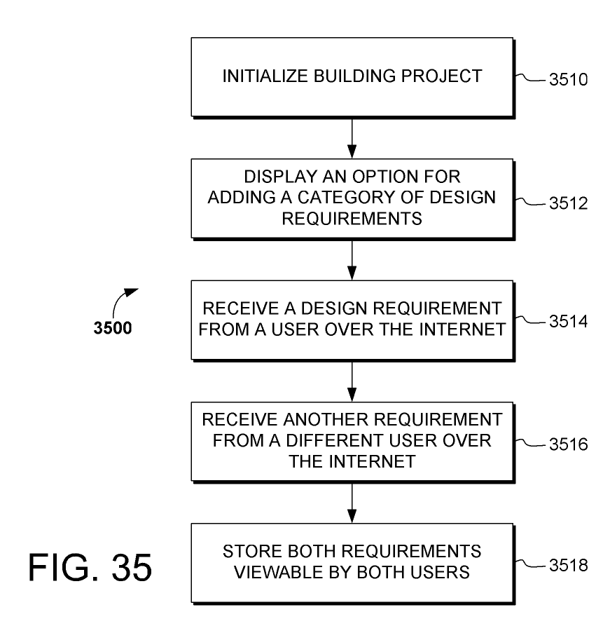

Turning next to FIG. 35, a diagram in accordance with an embodiment of the present invention is shown generally as 3500. As shown in FIG. 35 at step 3510, a building project 132 is initialized. In an embodiment, step 3510 includes configuration information, such as a user name or password, or a set of permissions associated with a user. In one example, an existing user is logging in to access a project and configuration information includes both user identification and password information. In another example, a new user, or a user without identification and password information in the system or readily available, will rely on permissions set for that user to initialize a project. In one specific example, initialization may occur for a user prior to establishing a password, but the user is identified in another way, such as by accessing a link received using certain contact information. In this example, the settings associated with the new user is information used to initialize a building project.

As shown at step 3512, an option for adding a category of design requirements 134 is presented to a user. Users of remote computing devices 110 through 118 are able to enter categories of requirements 134 with any name or purpose according to information received from a user. Requirements 134 in a category may be associated with each other on a display or in database 124. At step 3514, a design requirement is received from a first user over the Internet. The user contributes the design requirement 134 from a remote computing device in a first geographical location, such as devices 110 through 118.

Requirement 134 may be associated with metadata indicating the author, the time submitted and the relationship of requirement 134 to other data in database 124. A second design requirement is received from a user of another remote computing device in another geographical location over the Internet at step 3516 in FIG. 35. The second requirement is associated with metadata in an embodiment of the present invention. As shown at step 3518, both design requirements 134 are stored and viewable by the both users. Viewing design requirements 134 from either device 110 through 118 is done by selecting a link presented on user-interface 126. In an embodiment, requirements 134 are viewable during requests for project information, such as selecting to view more detailed requirements. In an embodiment, one level of design requirements 134, contributed by multiple users, are viewable in one portion of user interface 126 during request for and display of another level of design requirement 134 data in another portion of user interface 126.

Storage at step 3518 includes adding requirements 134 to a data structure, in some embodiments according to metadata based on the user interface 126 field used for inputting the information or the identity of the user. Another source of metadata for organizing data is the selection made by the user prior to or at the time of contribution of requirements 134. A request for project 132 information stored in database 124 is received and satisfied in an embodiment of the present invention.

In an embodiment, a template for an electronic message to a user or users of devices 110 through 118 is generated for communicating information through an electronic message application. An administrator may manage this application in an embodiment of the present invention. A command is received to automatically generate a resource or report 130 that memorializes design requirements 134 in an embodiment. Data stored in database 124 may be communicated to other programs and applications in embodiments, as discussed above, including but not limited to building information management systems, delimited files, or spreadsheet or word processing applications. In an embodiment of the present invention, comments associated with design requirements 134 are received, including outstanding or unsatisfied comments, and viewable by users with associated design requirements 134.

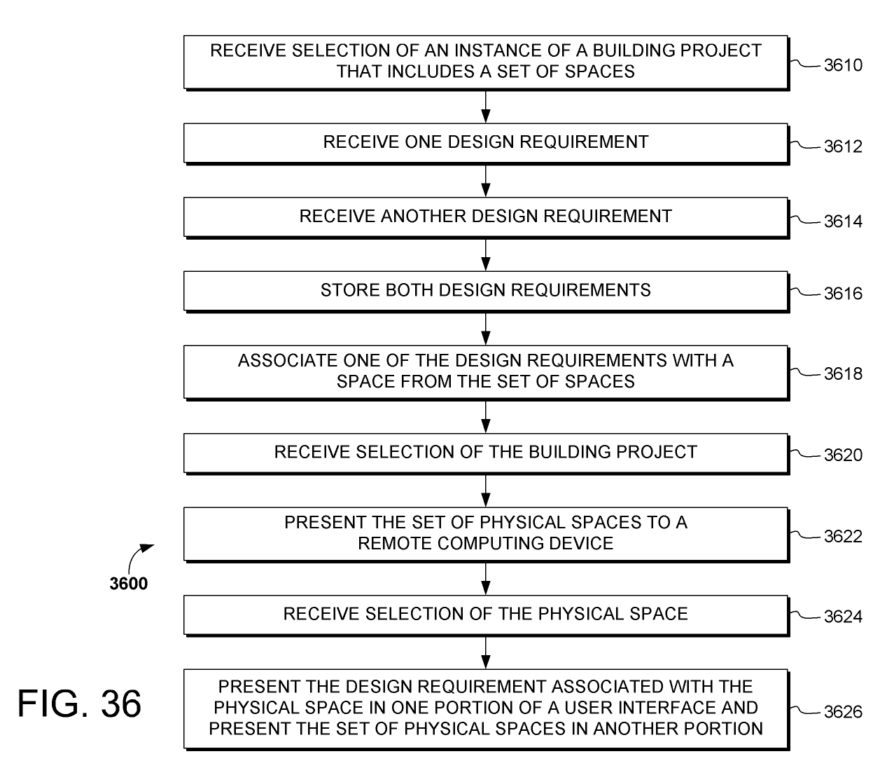

Turning next to FIG. 36, a diagram in accordance with an embodiment of the present invention is shown, designated generally as 3600. Step 3610 in FIG. 36 shows an instance of a building project 132 is received, including a set of spaces. At step 3612, a first design requirement 134 is received from a user in a first geographical location using a remote computing device, such as devices 110 through 118. Another design requirement from a second user in another geographical location is received at step 3614 in FIG. 36. The received design requirements 134 are stored, in extensible database 124, for example, in step 3616. Database 124 may be extended in response to storage of the design requirements 134, in some cases based on metadata associated with design requirements 134. As shown at 3618, one of the design requirements 134 is associated with one of the spaces from the set of spaces. This association may be made as a relationship in database 124, and it may have been indicated directly by users in embodiments of the present inventions, or determined based on input areas, selections or other ways associating a requirement 134 with an existing design requirement 134, such as a space.

At step 3620, selection of the instance of the building project 132 is received, and, in one embodiment, a set of physical-space indications is presented to a user via user interface 126 on a remote computing device 110. In one embodiment, portions of project 132 are viewable by both users. Selection of one physical-space indication, from among the set of physical-space indications, is selected at step 3624. As shown at step 3626, the design requirement 134 associated with the selected physical-space indication is presented to the user on one portion of interface 126 while the set of physical-space indications is presented on another portion of interface 126.

Physical-space indications, in a set or otherwise, may be stored and presented at different hierarchal levels in an embodiment, and display of physical-space indications may be dynamically adjustable. Design requirements 134 may be associated with physical-space indications, or other levels of design requirements 134 or each other, based on previously entered metadata or metadata automatically generated based on contributions by users. More than one physical-space indication may be associated with one design requirement 134 in embodiments of the present invention. In an embodiment, design requirement 134 is associated with the first physical-space indication based on first metadata and with a user based on second metadata. Design requirement 134 is viewable based on the first or the second metadata in an embodiment. Changes to the data structure are detected in an embodiment, and changes may be incorporated updated in a portion of project 132. Portions of project 132, or entire project 132, may be replicated and/or stored as a new project or portion of project. In one example, a change to database 124 by one user is be detected and a view presented to another user is updated to reflect the change.

In an embodiment of the present invention, update requests are received to update a data structure, stored, for example, in database 124. A data structure storing design requirement 134 is modified and stored, including information associated with the contributing user in an embodiment. In this specific example, a second request is received to update a data structure storing design requirement 134, which may be the same design requirement 134 updated previously or a different design requirement 134. Data structure storing design requirement 134 is updated and user-identification information is stored in an embodiment. Design requirements 134 may be included in an automatically-generated resource 130, which is a portable, self-contained document in an embodiment of the present invention. Resource 130 may be created automatically based on a single action, such as selection of an option by a user in one embodiment.

Many different arrangements of the various components depicted, as well as components not shown, are possible without departing from the scope of the claims below. Embodiments of our technology have been described with the intent to be illustrative rather than restrictive. Aspects of embodiments of the present invention may be uniquely numbered for purposes of patent drafting and for clarity in figures and descriptions included herein, such as remote computing devices 110 through 118. The particular numbering used does not preclude such aspects being similar or identical in embodiments of the present invention. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

The invention claimed is:

1. Computer-readable media having computer-executable instructions embodied thereon that, when executed, perform a method of enabling a plurality of users to contribute to a creation of a resource that memorializes design requirements of a physical structure to be made consistent with said design requirements, the method comprising:
at an application server, receiving configuration information that is useable by the server to initialize an instance of a building project;
initializing said building project, which includes a web-based user interface that presents building-project information that is stored in an extensible data structure;
presenting a category-addition component that enables reception of a user-defined design-requirements category (“category”) that will form a portion of said building project such that all requirements added to said project within said category will be related to each other by said category;
from a first remote computing device located in a first geographical location, receiving via the Internet a first design requirement associated with the category, wherein the first design requirement is automatically associated with a first field that is capable of receiving a first comment associated with the first design requirement;
from a second remote computing device located in a second geographical location, receiving via the Internet a second design requirement associated with the category, wherein the second design requirement is automatically associated with a second field that is capable of receiving a second comment associated with the second design requirement; and
storing the first design requirement and the second design requirement in said data structure, wherein the first design requirement and the second design requirement are automatically viewable by the first device and the second device incident to being stored in said data structure.

2. The media of claim 1, wherein configuration information includes one or more of:
a unique user identifier that identifies a user;
a password associated with said user identifier;
a set of permissions associated with said user, wherein said set of permissions limit what modifications said user is able to make to said extensible data structure.

3. The media of claim 1, wherein said storing includes automatically modifying said extensible data structure to accommodate storing said first design requirements when modification to said extensible data structure is necessary in order to store said first design requirements.

4. The media of claim 1, wherein the first and second design requirements are simultaneously viewable based on selection of a link indicating the category of requirements.

5. The media of claim 1, wherein the first design requirement and the second design requirement are viewable by the first device and the second device during a request for building-project information including the first design requirement from the database.

6. The media of claim 1, further comprising:
automatically generating a template of an electronic message that includes information to be communicated to one or more users associated with said building project; and
communicating said electronic message to said one or more users without the use of an email-client application.

7. The media of claim 1, further comprising:
receiving a request for building-project information that is stored in the extensible data structure; and
satisfying said request by returning an applicable response to a requester.

8. The media of claim 1, further comprising receiving a command to create the resource that memorializes design requirements; and
automatically creating said resource based on said building-project information.

9. The media of claim 8, further comprising communicating information from the data structure to one of the following: a building information management system, a delimited file, a spreadsheet software application, and a word-processing software application.

10. The media of claim 1, further comprising:
receiving a set of comments, wherein each of the comments is associated with a design requirement and at least one of the comments in the set requires action to be acted upon; and
presenting said at least one of the comments and an associated design requirement in response to a request from a remote computing device to receive the same.

11. Computer-readable media having computer-executable instructions embodied thereon that, when executed, perform a method of enabling a plurality of users to contribute to a creation of a resource that memorializes design requirements of a physical structure to be made consistent with said design requirements, the method comprising:
at an application server, receiving a selection of an instance of a building project, wherein the instance of a building project includes a set of indications of physical spaces, wherein said set includes,
(1) a first physical-space indication that indicates a first physical space, and
(2) other physical-space indications that indicate other physical spaces;
from a first remote computing device located in a first geographical location, receiving via the Internet a first design requirement associated with the instance of a building project,
from a second remote computing device located in a second geographical location, receiving via the Internet a second design requirement associated with the instance of a building project;
storing the first and second design requirements in an extensible data structure, wherein at least one of the first or second design requirements is associated with the first physical-space indication;
receiving a selection of the instance of a building project, wherein at least a portion of the instance of a building project is viewable via a first web-based user interface on the first remote computing device and a second web-based user interface on the second remote computing device;
automatically presenting at least a portion of the instance of a building project to the first remote computing device via the first web-based user interface, including the set of indications of physical-spaces;
receiving a selection of the first physical-space indication;
automatically presenting the design requirement associated with the first physical-space indication via a first portion of said first web-based user interface, wherein the set of indications of physical spaces is simultaneously viewable via a second portion of said first web-based user interface.

12. The media of claim 11,
wherein the first design requirement is associated with the first physical-space indication based on first metadata;
wherein the first design requirements is associated with a user of the first remote computing device based on second metadata; and
wherein the first design requirements is viewable based on the first or second metadata.

13. The media of claim 11, wherein the first physical-space indication is stored at a first hierarchal level and at least one of the other physical-space indications is stored at a second hierarchal level.

14. The media of claim 11, wherein the first physical-space indication and the at least one of the other physical-space indications are associated with the same design requirement.

15. The media of claim 11, wherein a view of the set of physical-space indications is dynamically adjustable without receiving a code modification from a user.

16. The media of claim 11, wherein automatically presenting at least a portion of the instance of a building project includes:
detecting a change to the extensible data structure; and
updating a relevant portion of the instance of the building project based on said change.

17. The media of claim 13, further comprising replicating an instance of said building project to create a second building project.

18. A memory for storing data, including design requirements of a physical structure to be made consistent with said design requirements, for access by an application executed on a server, the memory comprising an extensible data structure stored that includes:
an instance of a building project;
a plurality of users and user permissions associated with said building project
a set of physical-space features that describe one or more physical spaces associated with said building project;
at least one design requirement associated with each physical space indication, wherein each design requirement is associated with a user-defined design requirements category; and
an undeletable comment associated with one of the at least one design requirements.

19. The memory claim 18, further comprising the design requirement associated with one physical-space indication and the physical-space indication associated with more than one design requirement, thereby establishing a hierarchy of the physical-space indications and design requirements.

20. The memory for storing data of claim 18, further comprising
a first version of at least one design requirement for a physical space indication;
a second version of the at least one design requirement; and
a comparison of the first and second versions of the at least one design requirement.

21. The memory for storing data of claim 18, further comprising an additional instance of a separate building project, which is stored in the said data structure.

22. Computer-readable media having computer-executable instructions embodied thereon that, when executed, perform a method of memorializing design requirements of a physical structure to be made consistent with said design requirements, the method comprising:
at an application server, receiving a first update request that requests updating a data structure that stores design-requirement information;
updating said data structure by,
(1) modifying said design-requirement information consistent with said first update request, thereby causing a first update and resulting in updated design-requirement information;
(2) storing a first user identifier in connection with said first update such that said first update is associated with said a first user;
receiving a second update request that requests updating a data structure that stores design-requirement information, said second update request being received by a second user in different geographic location from where said first update request was sent;
updating said data structure by,
(1) modifying said updated design-requirement information consistent with said second update request, thereby causing a second update and resulting in current design-requirement information;
(2) storing a second user identifier in connection with said second update such that said second update is associated with a second user;
receiving a request to generate a portable resource memorialize said current design-requirement information;
automatically generating said portable resource, wherein said portable resource includes said design-requirement information, and wherein said portable resource is self contained in a single document.

23. A system for enabling a plurality of users to contribute to a creation of a resource that memorializes design requirements of a physical structure to be made consistent with said design requirements, the system comprising:
a mass-storage device that stores a data structure that includes said design requirements;
an application server that is (A) coupled to said mass-storage device and (B) coupled by way of the Internet to a plurality of remote devices that are located in a geographic area different from a location of said application server, wherein the application server includes a set of embodied computer-executable instructions that cause the server to perform a process that includes;
(1) receiving update requests from said plurality of remote devices;
(2) updating said data structure consistent with said update requests, thereby enabling said plurality of remote computing devices to present a user interface that reflects said update requests; and
(3) by way of a single action, automatically generating a portable resource that memorializes said design requirements.
